(19) United States
(12) Patent Application Publication
(10) Pub. No.: US 2016/0014059 A1
(43) Pub. Date: Jan. 14, 2016

(54) Presenting one or more types of interface(s) or media to calling and/or called user while acceptance of call

(71) Applicant: Yogesh Chunilal Rathod, Mumbai (IN)

(72) Inventor: Yogesh Chunilal Rathod, Mumbai (IN)

(21) Appl. No.: 14/870,067

(22) Filed: Sep. 30, 2015

(51) Int. Cl. H04L 12/58; G06F 3/0482; H04M 1/725; G06F 3/0484

(52) U.S. Cl. CPC H04L 51/046; G06F 3/04842; G06F 3/0482; H04L 51/10; H04M 1/72597

(57) ABSTRACT

A new type of communication channel, method, system, device, apparatus, platform, application & service is disclosed for enabling caller or calling party or inviter user(s) to send real-time invitation(s) or chat call to one or more callee or called party or invitee user(s) to real-time chat with calling party or inviter user(s) and within same session wait for acceptance of invitation(s) or chat call from said called party or invitee user(s) by said calling party or inviter user(s); enabling invitation(s) receiving or callee or called user(s) or invitee user(s) to accept chat call or invitation(s) or decline or not accept chat call or invitation(s) in real-time or within particular specific period of time or within same session or ignore chat call or invitation(s) within specified period of time or within same session; and in the event of acceptance of chat call or invitation(s) by callee or called party or invitee user(s), present chat call interface to caller or calling party or inviter user(s) and callee or called party or invitee user(s), wherein enabling callee or called party or invitation(s) accepted user(s) in real-time or within same session to access presented chat interface and participate in chat session with said calling party or invitation sender user(s) or inviter user(s) in real-time or within same session.

This is a continuation of International Application PCT/IB2014/059821, with an international filing date of 14 Mar. 2014, having title: Dynamically presenting chat interface to calling & called party while accepting of chat call by called party & up-to active chat call session.

### FIELD OF INVENTION

The present invention relates generally to enabling caller or calling party or inviter user(s) to send real-time invitation(s) or chat call to one or more callee or called party or invitee user(s) to real-time chat with calling party or inviter user(s) and within same session wait for acceptance of invitation(s) or chat call from said called party or invitee user(s) by said calling party or inviter user(s); enabling invitation(s) receiving or callee or called user(s) or invitee user(s) to accept chat call or invitation(s) or decline or not accept chat call or invitation(s) in real-time or within particular specific period of time or within same session or ignore chat call or invitation(s) within specified period of time or within same session; and in the event of acceptance of chat call or invitation(s) by callee or called party or invitee user(s), present chat call interface to caller or calling party or inviter user(s) and callee or called party or invitee user(s), wherein enabling callee or called party or invitation(s) accepted user(s) in real-time or within same session to access presented chat interface and participate in chat session with said calling party or invitation sender user(s) or inviter user(s) in real-time or within same session.

### BACKGROUND OF THE INVENTION

At present user or calling party can make phone call to called party and called party decline or ignore or answer or accept phone call within same session. The called party is a person who (or device that) answers a telephone call and calling party and called party started to talk with each other. Online chat may refer to any kind of communication over the Internet that offers a real-time transmission of text messages from sender to receiver. Chat messages are generally short in order to enable other participants to respond quickly. Thereby, a feeling similar to a spoken conversation is created, which distinguishes chatting from other text-based online communication forms such as Internet forums and email. Online chat may address point-to-point communications as well as multicast communications from one sender to many receivers and voice and video chat, or may be a feature of a web conferencing service.

Currently Skype enables user to make Skype voice or video call and in combination sent instant messages to called user or selected Skype user, but called user does not need to accept call for viewing instant messages or participate in chat during calling session. Present invention started chat call session when called party accept chat within particular period of time or during ringing of mobile particular period of time and end or terminates chat call when calling and/or called party ends or terminates chat call and during or between starting and ending of this chat session calling and called user converse or send or receive or share messages or contents with each other via chat interface. At the time of termination of particular chat call, system hides or closes chat interface from device or application of calling and called party and in one embodiment removing of contents or messages shared during said chat session from device or application or database of or related to calling and/or called party and/or server(s) and/or database(s) of server(s). Chat interface presented to calling and called party & chat session started only when called party accept chat call and chat interface presented to said calling and called party up-to end or termination of chat call by calling party or called party or both.

In voice call or phone call user have to talk with other users in real time and in real time or live chat user connect with other users and started chatting with each other. Present invention provides new type of communication channel, method, system, device, apparatus, platform, application & service enabling caller or calling party or inviter user(s) to send real-time invitation(s) or chat call to one or more callee or called party or invitee user(s) to real-time chat with calling party or inviter user(s) and within same session wait for acceptance of invitation(s) or chat call from said called party or invitee user(s) by said calling party or inviter user(s); enabling invitation(s) receiving or callee or called user(s) or invitee user(s) to accept chat call or invitation(s) or decline or not accept chat call or invitation(s) in real-time or within particular specific period of time or within same session or ignore chat call or invitation(s) within specified period of time or within same session; and in the event of acceptance of chat call or invitation(s) by callee or called party or invitee user(s), present chat call interface to caller or calling party or inviter user(s) and callee or called party or invitee user(s), wherein enabling callee or called party or invitation(s) accepted user(s) in real-time or within same session to access presented chat interface and participate in chat session with said calling party or invitation sender user(s) or inviter user(s) in real-time or within same session. So calling user can immediate connected with other preferred users who accept chat call invitation(s) within particular time or within duration of ringing of chat call and started chatting with each other up-to end of chat call by initiator or both the chat calling and/or chat called party. At present mobile phone enable user to make phone call and called party talk with calling party, whereas in one embodiment present invention enables user to make chat call similar fashion as making of phone call.

Therefore, it is with respect to these considerations and others that the present invention has been made.

### OBJECT OF THE INVENTION

The principal object of the present invention is to enabling caller or calling party or inviter user(s) to send real-time invitation(s) or chat call to one or more callee or called party or invitee user(s) to real-time chat with calling party or inviter user(s) and within same session wait for acceptance of invitation(s) or chat call from said called party or invitee user(s) by said calling party or inviter user(s); enabling invitation(s) receiving or callee or called user(s) or invitee user(s) to accept chat call or invitation(s) or decline or not accept chat call or invitation(s) in real-time or within particular specific period of time or within same session or ignore chat call or invitation(s) within specified period of time or within same session; and in the event of acceptance of chat call or invitation(s) by callee or called party or invitee user(s), present chat call interface to caller or calling party or inviter user(s) and callee or called party or invitee user(s), wherein enabling callee or called party or invitation(s) accepted user(s) in real-time or within same session to access presented chat interface and participate in chat session with said calling party or invitation sender user(s) or inviter user(s) in real-time or within same session.

The main object of the present invention is to enabling calling party to send or share or present one or more types of media including text, video, audio, photo, image, voice, file, documents, application, interface, wizards, widgets, form, web page, link, web site, data, user controls like menus, user actions, functions while chat calling or with chat call or acceptance of chat call or while establishment of or during chat call session to one or more or group(s) of contacts or called users. For example calling user can send, share, publish, upload, synchronize, provide & present one or more types of digital contents for one or more types of purposes, requirements, sales, purchases, activities, actions, events, transactions, workflow & tasks including present or share or send advertisements, deals, make order, book tickets, listen music, accept invitations, appointments, reminder, voting, make enquiry, provide presentation, provide feedbacks or suggestions, ask product or service details, ask for support, notifications, alerts, applications, one or more types of media, news, blogs, questions, search queries while chat calling or with chat call or acceptance of chat call or while establishment of or during chat call session to one or more or group(s) of contacts or called users or followers or following users or auto matched or preference base matched users of network(s), wherein called users accepts or ignore or decline chat calls from one or more calling users and accepted chat call users can view or read said presented preference based real-time advertisements, deals, notifications, alerts, news, blogs, & full or partial shared profile of calling user, access or view or download application(s) or participate with calling user (e.g. game applications), view or re-share one or more types of media & provide ratings, likes, dislikes & comments, real-time or near real-time view or read question(s) and provide answer(s), provide search query specific search result(s), real-time or on demand make payments, real-time fill survey forms, real-time fill questionnaires, user profile, job profile, matrimonial profile, feedback forms, suggestion forms, complaint forms, requirement details & one or more types of forms, access user actions with or without one or more types of shared contents(s) including Like & Dislike buttons, Provide Ratings, Provide Comments, Accept Invitations, Provide status or updates or presence information, Provide response, Provide answers, Register for particular applications or services or web sites options, buttons, combo box, list box, interactive controls, widgets, web page, check boxes, radio buttons, tabs, features, menus, buttons, functions, interfaces, objects and like.

The other object of the present invention is to auto chat calling to one or more contacts and/or users of network(s), wherein in one embodiment said auto chat calling are based on one or more types of activities, actions, interactions, events, transactions, senses, locations, check-in place(s), schedule, behavior, logs, status, updates, presence information, tasks, workflow, past chat calls, past chat call associate data, user profile, user data & metadata, shared contents, user contacts or connections.

### DETAIL DESCRIPTION OF THE PREFERRED EMBODIMENT

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the term “receiving” chat call(s), requests, updated status, responses, communications and any types of multimedia contents from a device or component includes receiving the chat call(s), requests, updated status, responses, communications, and any types of multimedia contents indirectly, such as when forwarded by one or more other devices or components. Similarly, “sending” chat call(s), requests, updated status, responses, communications, and any types of multimedia contents to a device or component includes sending the chat call(s), requests, updated status, responses, communications, and any types of multimedia contents indirectly, such as when forwarded by one or more other devices or components.

As used herein, the term “client application” refers to an application that runs on a client computing device. A client application may be written in one or more of a variety of languages, such as ‘C’, ‘C++’, ‘C#’, ‘J2ME’, Java, ASP.Net, VB.Net and the like. Browsers, email clients, text messaging clients, calendars, and games are examples of client applications. A mobile client application refers to a client application that runs on a mobile device.

As used herein, the term “network application” refers to a computer-based application that communicates, directly or indirectly, with at least one other component across a network. Web sites, email servers, messaging servers, and game servers are examples of network applications.

Briefly stated, the present invention is directed towards enabling caller or calling party or inviter user(s) to send real-time invitation(s) or chat call to one or more callee or called party or invitee user(s) to real-time chat with calling party or inviter user(s) and within same session wait for acceptance of invitation(s) or chat call from said called party or invitee user(s) by said calling party or inviter user(s); enabling invitation(s) receiving or callee or called user(s) or invitee user(s) to accept chat call or invitation(s) or decline or not accept chat call or invitation(s) in real-time or within particular specific period of time or within same session or ignore chat call or invitation(s) within specified period of time or within same session; and In the event of acceptance of chat call or invitation(s) by callee or called party or invitee user(s), present chat call interface to caller or calling party or inviter user(s) and callee or called party or invitee user(s), wherein enabling callee or called party or invitation(s) accepted user(s) in real-time or within same session to access presented chat interface and participate in chat session with said calling party or invitation sender user(s) or inviter user(s) in real-time or within same session.

In another embodiment enabling calling party to send or share or present one or more types of media including text, video, audio, photo, image, voice, application, interface, form, web page, link, web site, user controls like menus, user actions, functions while chat calling or with chat call or acceptance of chat call or while establishment of or during chat call session to one or more or group(s) of contacts or called users. For example calling user can send, share, publish, upload, synchronize, provide & present one or more types of digital contents for one or more types of purposes, activities, actions, events, transactions, workflow & tasks including present or share or send advertisements, deals, notifications, alerts, applications, one or more types of media, news, blogs, questions, search queries with chat call to one or more or group(s) of contacts or called users or followers or following users or auto matched or preference base matched users of network(s), wherein called users accepts or ignore or decline chat calls from one or more calling users and accepted chat call users can view or read said presented preference based real-time advertisements, deals, notifications, alerts, news, blogs, & full or partial shared profile of calling user, access or view or download application(s) or participate with calling user (e.g. game applications), view or re-share one or more types of media & provide ratings, likes, dislikes & comments, real-time or near real-time view or read question(s) and provide answer(s), provide search query specific search result(s), real-time or on demand make payments, real-time fill survey forms, real-time fill questionnaires, user profile, job profile, matrimonial profile, feedback forms, suggestion forms, complaint forms, requirement details & one or more types of forms, access user actions with or without one or more types of shared contents(s) including Like & Dislike buttons, Provide Ratings, Provide Comments, Accept Invitations, Provide status or updates or presence information, Provide response, Provide answers, Register for particular applications or services or web sites options, buttons, combo box, list box, interactive controls, widgets, web page, check boxes, radio buttons, tabs, features, menus, buttons, functions, interfaces, objects and like.

In another embodiment in the event of acceptance of invitation or chat call by one or more called parties, opening of chat interface and starting of chat session at device or application of calling and called party and enabling them to communicate, send or receive messages, voice messages & shared contents with each other(s) or establish communication among them.

In another embodiment chat calling or inviting, waiting for acceptance of chat call by called party, accepting or declining of chat call or invitation(s) by called party, chatting with invitations accepted called party or users & termination or ending of chat call by calling party or called party take place in real-time or within duration of chat call initiating, acceptance, chat conversations & ending of chat call or chat call session.

In another embodiment enabling calling party or invitation(s) sender user(s) or called party or inviter user(s) to ending of chat call before acceptance of invitation by invitee user(s).

In another embodiment enabling invitation(s) sender user(s) or inviter user(s) or calling party and/or invitation(s) receiving user(s) or invitee user(s) or called party to ending of chat call after acceptance of invitation and after starting or initiating of chat session or communications or during chat session.

In another embodiment ending of chat call when calling and/or called party declines or ends chat call or decline chat call or ignore chat call within period of time of ringing of phone or smart device.

In another embodiment ending of chat call including ending of chat session or closing of chat interface or ending of established communication between/among chat caller or calling party and chat callee or called party.

In another embodiment real-time invitation(s) lasts for specified period of time. In another embodiment specified period of time including particular time of ringing or vibrating of phone or notifying to phone.

In another embodiment notifying user(s) or maintaining chat call logs about recent chat calls, past chat calls, missed chat calls, duration of chat calls.

In another embodiment auto chat calling to one or more contacts and/or users of network(s), wherein in one embodiment said auto chat calling are based on one or more types of activities, actions, interactions, events, transactions, senses, locations, check-in place(s), behavior, logs, status, updates, presence information, tasks, workflow, past chat calls, past chat call associate data, user profile, user data & metadata, shared contents, user contacts or connections.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 illustrates a block diagram of a chat call based real-time or live chatting services system configured to implement the chat call based real-time or live chatting, according to some embodiments.

FIG. 2 illustrates exemplary graphical user interface (GUI) for enabling chat calling users to make chat call to called user(s) and chatting with chat call accepted user within specified period of time;

FIG. 3 illustrates exemplary presented graphical user interface (GUI) when chat calling user makes chat call to one or more called users and wait for answer or acceptance of invitation from called user(s);

FIG. 4 illustrates exemplary presented graphical user interface (GUI) for called user while chat calling by other user to called party;

FIG. 5 & FIG. 6 illustrates exemplary presented chat graphical user interface (GUI) for calling and called user at the time of acceptance of chat call by called user.

In one embodiment FIG. 7 illustrates exemplary presented graphical user interface (GUI) for enabling user to select, input, apply, set & update privacy settings and preferences related chat call;

FIGS. 8 to 14 illustrates exemplary graphical user interface (GUI) relates to group chat call by calling user to selected called users;

FIGS. 15 illustrates exemplary graphical user interface (GUI) for enabling user to manage one or more chat calls initiated by calling user to one or more or group(s) of called users, chat call accepted by one or more called users, waiting for acceptance of chat calls, accept or reject or ignore or remove or block chat calls of other calling users, end or terminate existing chat calls, add or merge user to one or more chat calls;

FIG. 16 illustrates an example computer system suitable for implementing various components of the system and method for real time chat call based chatting system, according to some embodiments.

While the invention is described herein by way of example for several embodiments and illustrative drawings, those skilled in the art will recognize that the invention is not limited to the embodiments or drawings described. It should be understood, that the drawings and detailed description thereto are not intended to limit the invention to the particular form disclosed, but on the contrary, the intention is to cover all modifications, equivalents and alternatives falling within the spirit and scope of the present invention. The headings used herein are for organizational purposes only and are not meant to be used to limit the scope of the description. As used throughout this application, the word “may” is used in a permissive sense (e.g., meaning having the potential to), rather than the mandatory sense (e.g., meaning must). Similarly, the words “include”, “including”, and “includes” mean including, but not limited to.

### DETAILED DESCRIPTION OF THE DRAWINGS

Various embodiments of a system and method for request based real-time or near real-time or live broadcasting, sharing and providing user services are described. In the following description, numerous specific details are set forth to provide a thorough understanding of claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter.

A system and methods for real-time chat calling based chatting is described herein. In one embodiment the calling party (also called caller, call originator) is a person who (or device that) initiates a chat call over the network, usually by selecting one or more contact(s) and/or group(s) of contacts or dialing a chat call number. The called party is a person who (or device that) answers a chat call. The person who (or device that) initiates a chat call is the calling party. A chat call is a connection over a network between the calling party and the called party. When called party or parties or device(s) or application(s) accept chat call or accept within particular period of time or accept during ringing of device or application then calling and called party or user is presented with chat interface for enabling them to communicate, collaborate, share, send, receive messages, media including photo, video, audio, image, voice, file, emoticons, location information, user profile, web page, widget, contacts, links, application, data, forms and one or more types of digital contents. After establishing of connection between or among calling or called party or parties, they can terminate or hung up chat call like phone call. Called party or parties also enable to decline or reject or ignore chat call and calling chat call later via missed chat call alerts or notifications or logs.

The various mobile devices of the users may be connected to each other and to a central server via a wireless network. The mobile device users can chat calling one or more other users for chatting, communicating, collaborating, participating & sharing with them.

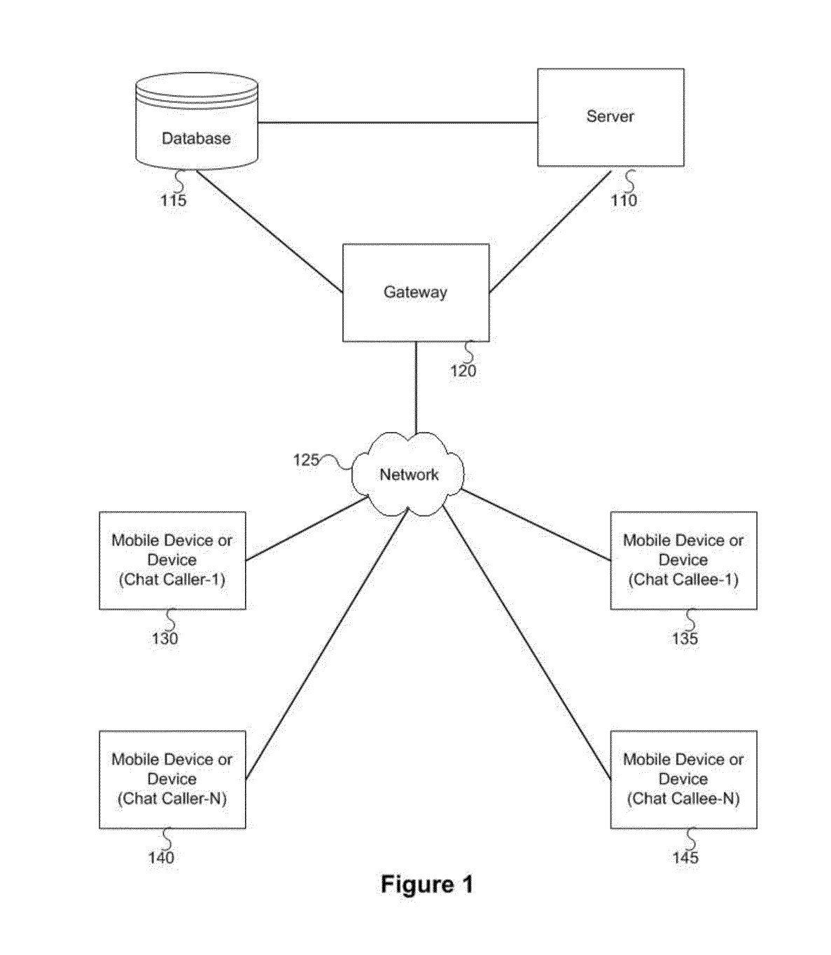

The system for real time chat call based chatting may be referred to herein, for simplicity, as the “real time chat call based chatting system”. FIG. 1 illustrates a block diagram of a real time chat call based chatting system configured to implement the real time chat calling to one or more called parties for chatting, sharing, communicating, sharing & collaborating with called parties up-to termination of chat call by calling and/or called parties. While FIG. 1 illustrates a gateway 120, a database 115 and a server 110 as separate entities, the illustration is provided for example purposes only and is not meant to limit the configuration of the real time chat call based chatting system. In some embodiments, gateway 120, database 115 and server 110 may be implemented in the real time chat call based chatting system as separate systems, a single system, or any combination of systems.

As illustrated in FIG. 1, the real time chat call based chatting system may include a chat caller(s) or chat calling party mobile device(s) 130/140, chat callee or chat called party mobile device(s) 135/ 145. Mobile devices 130/140/135/145 may be particular set number of or an arbitrary number of mobile devices which may be capable of calling one or more selected users or contacts for chatting to called parties device(s). Each mobile device in the set of chat caller(s) 130/140 and chat callee mobile device(s) 135/145 may be configured to communicate, via a wireless connection, with each one of the other mobile devices 130/140/135/145. Each one of the mobile devices 130/140/135/145 may also be configured to communicate, via a wireless connection, to a network 125, as illustrated in FIG. 1. The wireless connections of mobile devices 130/140/135/145 may be implemented within a wireless network such as a Bluetooth network or a wireless LAN.

As illustrated in FIG. 1, the real time chat call based chatting system may include gateway 120. Gateway 120 may be a web gateway which may be configured to communicate with other entities of the real time chat call based chatting system via wired and/or wireless network connections. As illustrated in FIG. 1, gateway 120 may communicate with mobile devices 130/140/135/145 via network 125. In various embodiments, gateway 120 may be connected to network 125 via a wired and/or wireless network connection. As illustrated in FIG. 1, gateway 120 may be connected to database 115 and server 110 of the real time chat call based chatting system. In various embodiments, gateway 120 may be connected to database 115 and/or server 110 via a wired or a wireless network connection.

Gateway 120 may be configured to send and receive data (e.g., chat call requests and shared contents or media including text, message, links, videos, photos, audio, images, voice, and sound to/from mobile devices 130/140/135/145. For example, gateway 120 may be configured to receive chat call request(s) and/or a shared contents or media including text, message, links, videos, photos, audio, images, voice, and sound from a mobile device and may send the chat call request(s) and/or a shared contents or media including text, message, links, videos, photos, audio, images, voice, and sound to database 115 for storage. As another example, gateway 120 may be configured to send chat call request(s) and/or a shared contents or media including text, message, links, videos, photos, audio, images, voice, and sound stored in database 115 to mobile devices 130/140/135/145. Gateway 120 may be configured to receive chat call request(s) from mobile devices 130/140/135/145.

For example, gateway 120 may receive a chat call request(s) from a mobile device(s) or calling party or parties and notify via ringing or any other method & present to target receiver(s) or called party or parties for enabling called party to accept or answer chat call for chatting or sharing with calling party or reject or ignore chat call(s). Gateway 120 may be configured to inform server 110 of updated data. For example, gateway 120 may be configured to notify server 110 when a new shared or published or presented messages, videos, audio, photos, images & voice has been received from a mobile device and stored on database 115.

As illustrated in FIG. 1, the real time chat call based chatting system may include a database, such as database 115. Database 115 may be connected to gateway 120 and server 110 via wired and/or wireless connections. Database 115 may be configured to store a database of real-time or near real time broadcasted or streamed or shared or send messages, videos, audio, photos, images & voice received from mobile devices 130/140/135/145 via network 125 and gateway 120. The database of media or content stored in database 115 may include messages, text, links, videos, audio, photos, images, files, objects, applications, web pages & voice data, associate metadata including description, sender or receiver name & identity & system data including date & time.

Database 115 may also be configured to receive and service chat call requests from gateway 120. For example, database 115 may receive, via gateway 120, a chat call request from a mobile device and may service the chat call request by notifying called party or parties regarding chat call via ringing or other methods of notification or alerts and establishing connection with calling party for chatting with them. Database 115 may be configured to communicate with server 110.

As illustrated in FIG. 1, the real time chat call based chatting system may include a server, such as server 110. Server may be connected to database 115 and gateway 120 via wired and/or wireless connections. As described above, server 110 may be notified, by gateway 120, of new messages, shared contents including media, videos, audio, photos, images & voice that have been added to the real-time chat call request specific messages & shared contents including videos, audio, photos, images & voice image stored in database 115. Server 110 may be configured to send updated metadata for each new messages & shared contents including videos, audio, photos, images & voice to database 115 such that the metadata identifies the messages & shared contents including videos, audio, photos, images & voice as a new messages & shared contents including videos, audio, photos, images & voice in database 115.

In one embodiment enabling caller or calling party or inviter user(s) 130 and/or 140 to send real-time invitation(s) or chat call (e.g. FIG. 220) to one or more callee or called party or invitee user(s) 135 and/or 145 to real-time chat with calling party or inviter user(s) 130 and/or 140 and within same session wait for acceptance of invitation(s) or chat call from said called party or invitee user(s) 135 and/or 145 by said calling party or inviter user(s) 130 and/or 140; enabling invitation(s) receiving or callee or called user(s) or invitee user(s) 135 and/or 145 to accept chat call or invitation(s) (e.g. FIG. 440 or 1050 or 1150) or decline or not accept chat call or invitation(s) (e.g. FIG. 435 or 1045 or 1145) in real-time or within particular specific period of time or within same session or ignore chat call or invitation(s) within specified period of time or within same session; and in the event of acceptance of chat call or invitation(s) by callee or called party or invitee user(s) 135 and/or 145, present chat call interface (e.g. see FIG. 520 or 620 or 1220 or 1320 or 1420 or 1520) to caller or calling party or inviter user(s) 130 and/or 140 and callee or called party or invitee user(s) 135 and/or 145, wherein enabling callee or called party or invitation(s) accepted user(s) 135 and/or 145 in real-time or within same session to access presented chat interface (e.g. see FIG. 520 or 620 or 1220 or 1320 or 1420 or 1520) and participate in chat session with said calling party or invitation sender user(s) or inviter user(s) 130 and/or 140 in real-time or within same session.

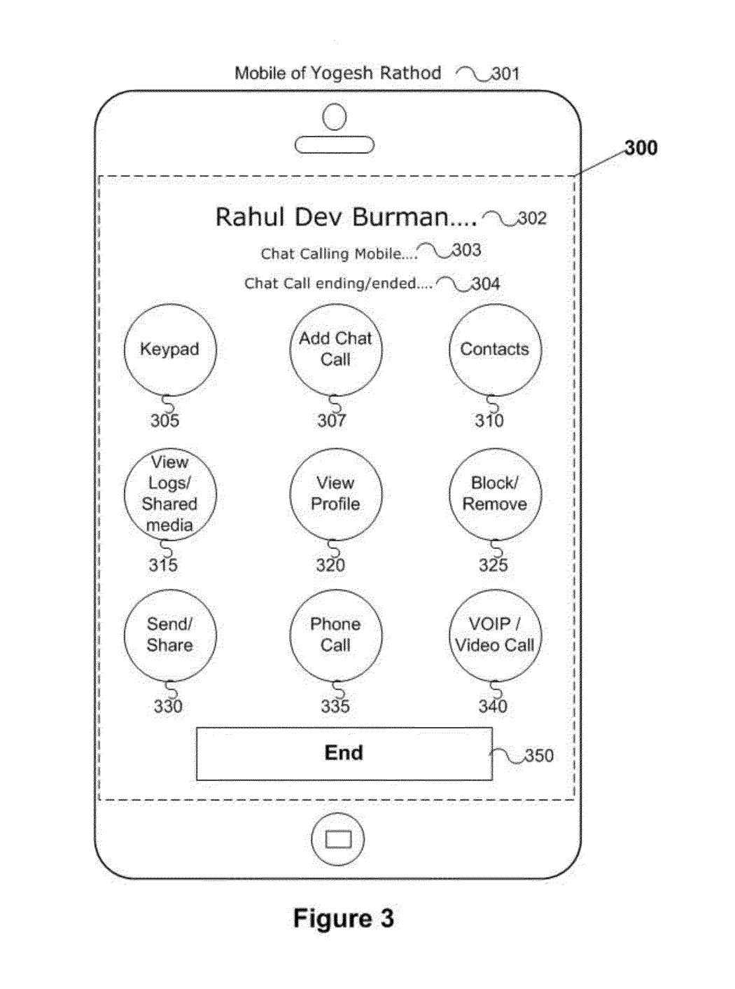

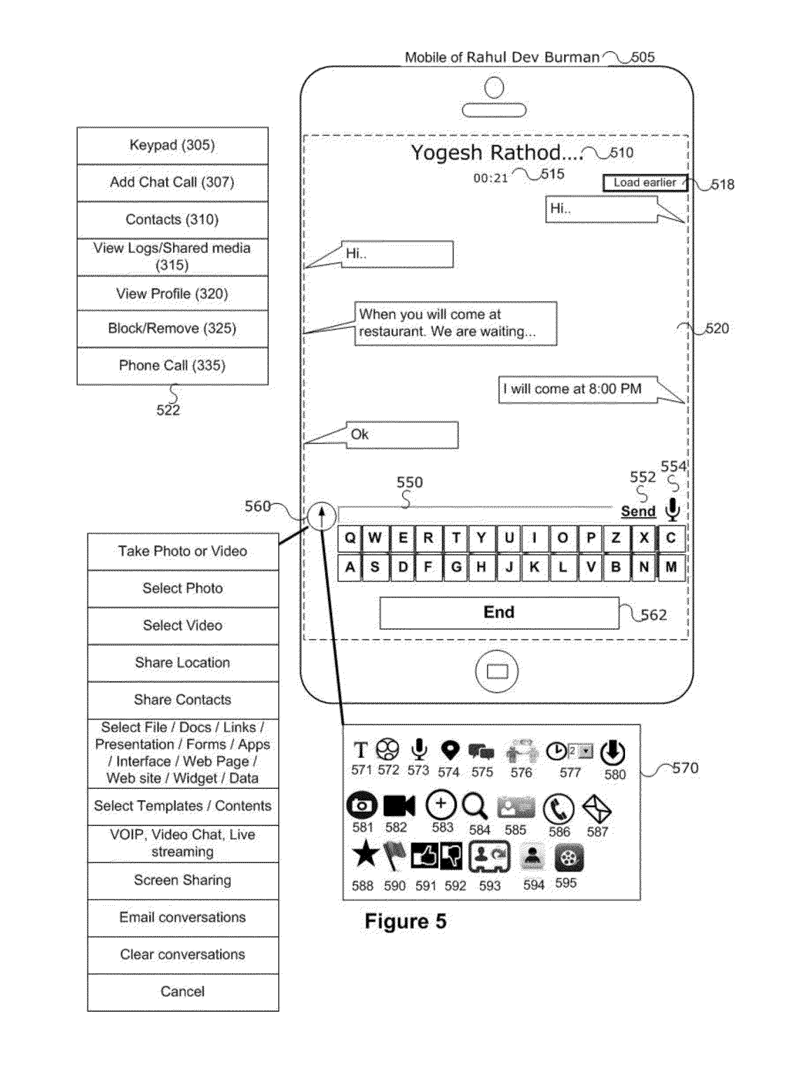

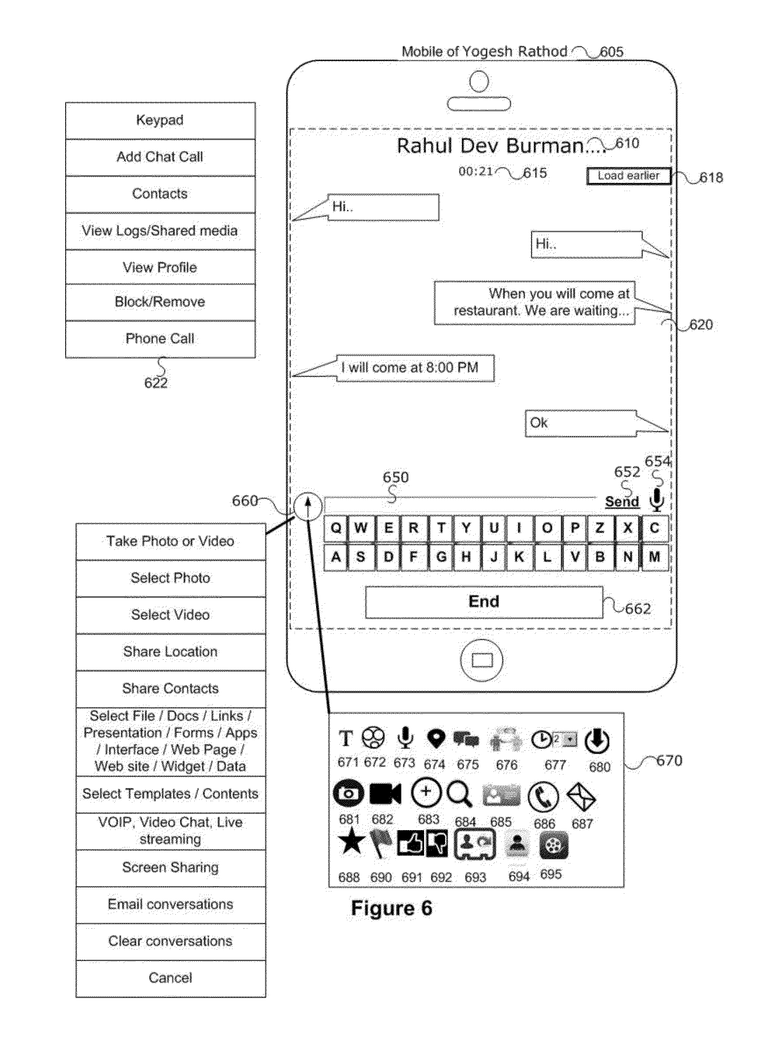

In another embodiment enabling calling party (e.g. 130/140/201) to send or share or present one or more types of media including text, video, audio, photo, image, voice, application, interface, form, web page, link, web site, user controls like menus, user actions, functions 245 while chat calling 220 or FIG. 3 (300) or with chat call 220 or FIG. 3 (300) or acceptance of chat call (440 or FIG. 5) or while establishment of or during chat call session (FIG. 5) to one or more or group(s) of contacts or called users (e.g. 505, 1010, 1110, 1205, 1305, 1405 & 1505). For example calling user (e.g. 130/140/201) can send, share, publish, upload, synchronize, provide & present one or more types of digital contents (245) for one or more types of purposes, activities, actions, events, transactions, workflow & tasks including present or share or send advertisements, deals, notifications, alerts, applications, one or more types of media, news, blogs, questions, search queries with chat call to one or more or group(s) of contacts or called users or followers or following users or auto matched or preference base matched users of network(s) (205 or 805), wherein called users (e.g. 505, 1010, 1110, 1205, 1305, 1405 & 1505) accepts (440) or ignore or decline (435) chat calls from one or more calling users (e.g. 130/140/201) and accepted chat call users (e.g. 505, 1010, 1110, 1205, 1305, 1405 & 1505) can view or read said presented preference based real-time advertisements, deals, notifications, alerts, news, blogs, & full or partial shared profile of calling user, access or view or download application(s) or participate with calling user (e.g. game applications), view or re-share one or more types of media & provide ratings, likes, dislikes & comments, real-time or near real-time view or read question(s) and provide answer(s), provide search query specific search result(s), real-time or on demand make payments, real-time fill survey forms, real-time fill questionnaires, user profile, job profile, matrimonial profile, feedback forms, suggestion forms, complaint forms, requirement details & one or more types of forms, access user actions with or without one or more types of shared contents(s) including Like & Dislike buttons, Provide Ratings, Provide Comments, Accept Invitations, Provide status or updates or presence information, Provide response, Provide answers, Register for particular applications or services or web sites options, buttons, combo box, list box, interactive controls, widgets, web page, check boxes, radio buttons, tabs, features, menus, buttons, functions, interfaces, objects and like.

In one embodiment auto chat calling to one or more contacts and/or users of network(s), wherein in one embodiment said auto chat calling are based on one or more types of activities, actions, interactions, events, transactions, senses, locations, check-in place(s), behavior, logs, status, updates, presence information, tasks, workflow, past chat calls, past chat call associate data, user profile, user data & metadata, shared contents, user contacts or connections.

In one embodiment individuals may download real time chat call based chatting system's application or service from a variety of on-line application stores. In some cases, the application is pre-loaded to an individual's phone by a network carrier or device manufacturer. Once the application has been downloaded to a mobile device 130/140/135/145, an individual is required to register with real time chat call based chatting system's application or service using his or her mobile device 130/140/135/145. During the registration process, individuals may asked to read and accept real time chat call based chatting system's application or service's Terms of Service and Privacy Policy. The Terms of Service and Privacy Policy may provide in a pop-up window at the time of registration and may also available on-line on real time chat call based chatting system's application or service's website. Once an individual has read and accepted real time chat call based chatting system's application or service's terms of service, he or she may asked to specify the country in which they reside and to provide their mobile phone number. In some cases, the application may also ask a registrant for their preferred notification name (i.e., the name the user wishes to appear in out-going messages). Once an individual has provided his or her country code and mobile telephone number, the application may collects the following information from the registrant's mobile device including device identifier information, mobile subscriber ID, mobile country code, and mobile network code. Using that information, real time chat call based chatting system's application or service may sends an account confirmation message to the registrant by way of standard SMS. Using the registrant's reply to that message, real time chat call based chatting system's application or service then verifies that the personal information provided by the user during the registration process matches that attached to the mobile device. Once confirmed, a user is registered and his or her account is activated. The user may then begin sending and receiving chat call requests, accepting or rejecting or ignoring real-time chat call request(s), send, receive, share messages, media, contents with other real time chat call based chatting system's application or service users world-wide. In order to facilitate contact between application users, real time chat call based chatting system's application or service relies on a user's address book to populate his or her real time chat call based chatting system's application or service related “All Contacts” list. Once a user consents to the use of his or her address book, contact information from the user's mobile device is periodically transmitted to real time chat call based chatting system's application or service's server(s) 110 connected database(s) 115 to assist in the identification of other real time chat call based chatting system's application or service users. In one embodiment, the application is designed to upload a user's mobile address book to real time chat call based chatting system's application or service's server(s) 110 up to one or more times daily or periodically, or as initiated by the user during a contact refresh. Personal information collected during the contact discovery process may limited to mobile numbers. Association between contact names and numbers may occur on a user's device only, and not by virtue of any data matching by real time chat call based chatting system's application or service. Once a user has consented to the use of his or her contact information for contact discovery, mobile numbers from the user's address book are transferred securely to real time chat call based chatting system's application or service's servers using Secure Socket Layer/Transport Layer Security or SSL/TLS encryption. Once uploaded, a contact number is categorized by real time chat call based chatting system's application or service's server(s) 110 as being either “in-network” (i.e., registered with real time chat call based chatting system's application or service) or “out-of-network”. Only numbers listed as in-network can be contacted using the real time chat call based chatting system's application or service. An out-of-network number would only become associated with a real time chat call based chatting system's application or service user once the application was installed and registered on a device with that number. In-network numbers may stored as original values (i.e., in clear text) on real time chat call based chatting system's application or service server(s) 110. Out-of-network numbers are stored as one-way, irreversibly hashed values. Real time chat call based chatting system's application or service may use a multi-step treatment of the numbers, with the key step being an “MD5” hash function. The phone number and a fixed salt value serve as input to the hash function, and the output is truncated to 53 bits and combined with the country code for the number. The result is a 64-bit value which is stored in data tables on real time chat call based chatting system's application or service's server(s) 110. This procedure is designed to render out-of-network numbers (i.e., the mobile numbers of non-users) anonymous.

In one embodiment real time chat call based chatting system's application or service's messenger service provides chat calling or calling for requesting chat with called users and an instant messaging system that can be used across mobile devices, whether BlackBerrys, iPhones, Windows-based phones or Androids. BlackBerry users, for example, may message Android users and iPhone users, and vice versa—a feature generally not available on the proprietary messaging systems built into phones by mobile manufacturers. In order to send and receive messages using the application, however, both the sender and recipient of a message must have the real time chat call based chatting system's application or service installed or subscribed and registered on his or her device.

In one embodiment real time chat call based chatting system's application or service uses a customized version of the open standard Extensible Messaging and Presence Protocol (XMPP). Upon installation, it creates a user account using one's phone number as the username (Jabber ID: [phone number]@s.chatcall.net). Real time chat call based chatting system's application or service or software automatically compares all the phone numbers from the device's address book with its central database(s) 115 of real time chat call based chatting system's application or service users to automatically add contacts to the user's contact list.

In one embodiment multimedia messages are sent by uploading the image, audio or video to be sent to an HTTP server and then sending a link to the content along with its Base64 encoded thumbnail.

In one embodiment real time chat call based chatting system's application or service may required users to upload their mobile phone's entire address book to real time chat call based chatting system's application or service server(s) 110 so that real time chat call based chatting system's application or service could discover who, among the users' contacts, is available via real time chat call based chatting system's application or service. While this is a fast and convenient way to quickly find and connect the user with contacts who are also using real time chat call based chatting system's application or service, it means that their address book was then mirrored on the real time chat call based chatting system's application or service server(s) 110, including contact information for contacts who are not using real time chat call based chatting system's application or service.

In another embodiment real time chat call based chatting system or part of real time chat call based chatting system may or can integrate, host & access including chat calling, answering or accepting chat call, accessing chat interface and chat session with/at/via 3rd parties web sites, web pages, user profile, applications, services, networks, servers & devices via application programming interface (API), web service(s) and one or more types of communication interfaces.

In another embodiment real time chat call based chatting system or part of real time chat call based chatting system are based on clientless platform or browser based or online web site, embedded client, offline or connected client, smart client or mobile application.

In another embodiment real time chat call based chatting system available for multi users, multi members, wherein administrator can create one or more accounts, assign one or more features to each member, provides rights, privacy settings & privileges to one or more members or accounts.

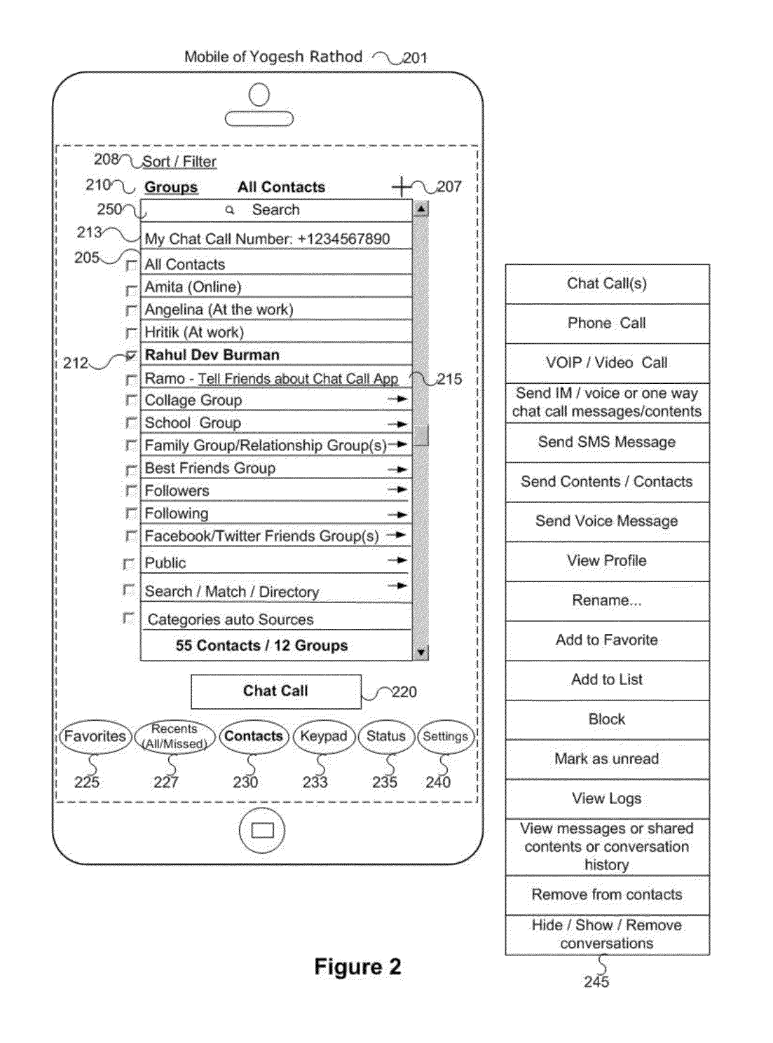

FIG. 2 illustrates exemplary graphical user interface (GUI) for enabling exemplary user or calling user 201 via exemplary device 130/140 to in some embodiment access, sort or filter 208 contacts 205 including sort rank or favorite or group(s) or category wise, sort or filter online or available users & sort recent chat calls, create group(s) 210 of contacts 205, add new contacts 207, search 250 contacts 205, favorite or rank 225 one or more contacts 205, select one or more contacts 205 of real time chat call based chatting system's application or service and making chat call via chat call button 220 to one or more called parties or selected user(s) or contacts (e.g. contact user “Rahul Dev Burman”) 212. User can view logs & details of recent, all, missed, canceled, incoming & outgoing chat calls via button or link or option 227 including chat call duration, date & time, chat call user name or chat call number. User can view all contacts and associate interface via “contact” button or link or option 230. In another embodiment real time chat call based chatting system's application or service provides chat call number 213 to each or premium or paid or sponsored users which user can dial or use or select or input via keypad or dialer 233 for connecting or calling said chat call number associate user for chatting or sharing with said called and chat call accepted user. In another embodiment enabling automatically or enabling user to provide, set, select, select from auto identified, share, apply, send & publish user's status, availability or presence information for other users via status button or link or option 235. In another embodiment user is enable to apply, set, select, input and manage one or more types of privacy settings & preferences via settings option 240 which are discuss in detail in FIG. 7.

In another embodiment list of contact 205 also present availability status, tell friends who not installed real time chat call based chatting system's application or service about installing of chat call application and associate metadata, numbers, statistics with each contact item. In another embodiment list of contact 205 also present group(s), followers, following users or contacts, categories directories of users of networks and enabling user to search and match allowed categories lists of users who have similar interest or matched with user provided search keywords and enable to subscribe, bookmark and follow them.

In another embodiment enabling user to access & use one or more options, user actions, functions, menu items, applications, services, features 245 associate or provided with one or more or one or more selected contacts and/or group(s) of contacts 205 including making chat call(s), general phone call, VOIP or voice or video call, send instant messages or share contents or one way chat call messages i.e. enable to make chat call to one or more users and those who not accept chat call, send them message(s) or shared contents, send SMS, send or share one or more types of media including contacts, text, video, photo, image, audio, voice, file, documents & links, enabling to view user or selected contact's profile(s), rename name of particular contact, add one or more contact to favorite contacts or one or more categories list(s) of contacts, block or remove or show or hide contact(s), view chat call related logs, activities, actions, events, transactions, locations, conversations, history, story, enable to hide or show or remove or backup or restore conversations.

FIG. 3 illustrates exemplary presented graphical user interface (GUI) when user makes chat call to one or more users. For example when user [Yogesh Rathod] 201 selects or double tap on contact [Rahul Dev Burman] 212 from list of all contacts 205 or click or touch on chat call label or button or link or option 220 for making chat call to said selected or tapped contact [Rahul Dev Burman] 212 then user [Yogesh Rathod] 201/301 is presented with screen or interface 300, wherein user is waiting for answer or invitation acceptance or chat call acceptance from called party or parties e.g. [Rahul Dev Burman] 212/302. In another embodiment called party is notified with/via ringing and/or vibrating or notification message that user [Yogesh Rathod] 201 is making chat call to user [Rahul Dev Burman] 212/302 and user [Rahul Dev Burman] 212/302 have to reject or ignore or accept/answer said chat call within particular or set period of time (e.g. 30 seconds or 1 minutes). User is provided with status i.e. “chat calling mobile” 303. In one embodiment user can end or terminate or hung-up chat call before reply or response or acceptance of chat call by called party or after acceptance of chat call e.g. [Rahul Dev Burman] 212/302 where user is presented with “chat call ending or ended” status 304. In another embodiment during chat calling, calling user [Yogesh Rathod] 201 can use keypad 305 for input or enter extensions, commands, numbers (e.g. press 1 for sales department or press 2 for support and like or route chat call to multiple destinations including cell phones, home phones and work phones or other features such as Menus, Queues or Recordings. In another embodiment during chat calling, calling user [Yogesh Rathod] 201 can use add chat call option 307 for use conferencing calling. To use conferencing calling on user's device or application, user can do the following: chat call the first person user want to include on the chat call (or have them chat call to user), Once they've answered, user can tap the Add Chat Call 307 button to put them on hold.

this brings up user's contacts list. User can browse through it to the person user want to add to the chat call, tap their name, and then tap their phone number that user want to call. User can also choose the keypad from this screen and dial the next number directly. When the next person user are calling has answered, tap the Merge Chat Calls button to conference all the lines together. If user are already on the chat call and another participant calls user, tap the Hold and Answer button that pops up on the screen and the tap Merge Chat Calls to join the chat calls together into a conference. I(n another embodiment when user use user's mobile device or application to host a conference call, user can speak to one participant privately, or disconnect people from the call individually. In another embodiment user can also choose to flip between two chat calls without conferencing them together using the Swap Calls button. If user has got two chat calls coming into user's mobile phone or device, user can simply tap the Swap Calls button to put the current chat call on hold and move to the other. Tap the button again to reverse the process.

In another embodiment during or while chat calling, calling user [e.g. Yogesh Rathod] 201 can access and dial or chat calling to one or more other contacts via contacts option 310.

In another embodiment during or while chat calling, calling user [e.g. Yogesh Rathod] 201 can view logs and shared media of called user via option 315.

In another embodiment during or while chat calling, calling user [e.g. Yogesh Rathod] 201 can view profile of called user via option 320.

In another embodiment during or while chat calling, calling user [e.g. Yogesh Rathod] 201 can block or remove called user(s) from contacts via option 325.

In another embodiment during or while chat calling, calling user [e.g. Yogesh Rathod] 201 is enabled to send or share contents via option 330.

In another embodiment during or while chat calling, calling user [e.g. Yogesh Rathod] 201 is enabled to make ordinary phone call via option 335.

In another embodiment during or while chat calling, calling user [e.g. Yogesh Rathod] 201 is enabled to make VOIP or voice or video call via option 340.

In another embodiment during or while chat calling, calling user [e.g. Yogesh Rathod] 201 is enabled to end or terminate chat call via button or option 350.

In another embodiment during or while chat calling, calling user [e.g. Yogesh Rathod] 201 is enabled to end or terminate or hung up chat call any time after calling to called user including before or after acceptance of chat call by called party.

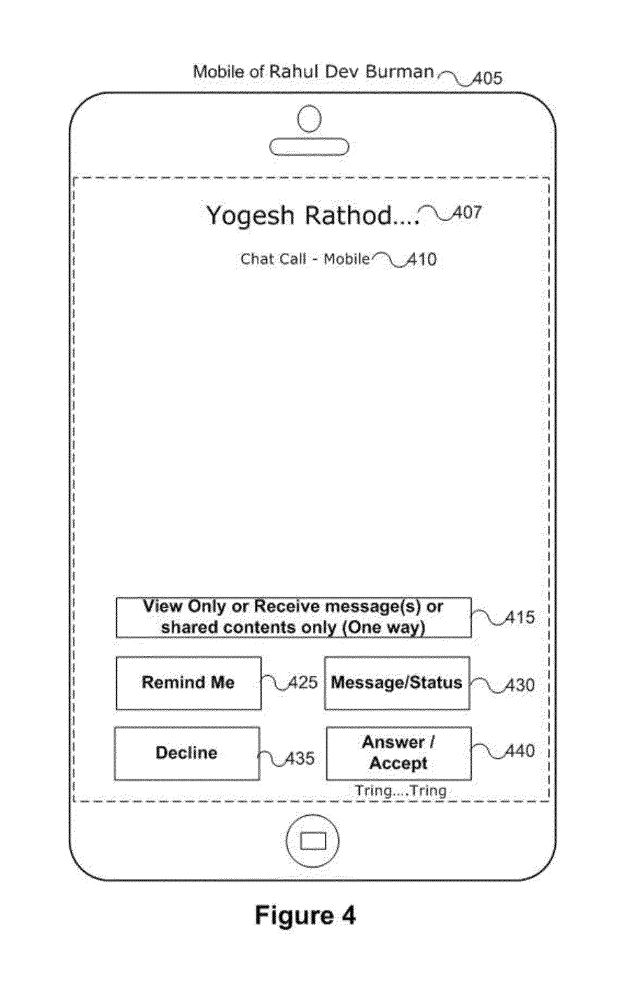

FIG. 4 illustrates exemplary presented graphical user interface (GUI) for called user while chat calling by other user to called party or chat call receiving user e.g. [Rahul Dev Burman] 405. Called user e.g. [Rahul Dev Burman] 405 can view chat caller id or name of calling user e.g. [Yogesh Rathod] 407 and chat calling status 410. Called user e.g. [Rahul Dev Burman] 405 is enabled to ignore or decline chat call 435 or send message or status 430 to notify calling user that user will call later or remind user within particular period of time 425 or accept chat call only for receiving shared contents 415 or answer or accept chat call 440 within particular period of time or ringing of chat calling.

FIG. 5 & FIG. 6 illustrates exemplary presented chat graphical user interface (GUI) for calling and called user at the time of acceptance of chat call by called user. When calling user e.g. [Yogesh Rathod] 201 makes chat call 220 via device 130/140 to selected user e.g. [Rahul Dev Burman] 212 and called user e.g. [Rahul Dev Burman] 405 accepts or answers chat call 440 via user device 135 or 145 then called user e.g. [Rahul Dev Burman] 505 and calling user e.g. [Yogesh Rathod] 605 is presented with chat interface with various types of options. In one embodiment called user e.g. [Rahul Dev Burman] 505 and calling user e.g. [Yogesh Rathod] 605 is/are enable to access various options 522 as discuss in detail in FIG. 3 and can send 522 one or more messages 550 or voice messages 554 and can share one or more types of media 560 including captured or recorded or searched or matched or selected photo, video, file, links, documents, images, audio, voice, presentation, forms, applications, user controls or objects, interfaces, screens, web page, web site, widget, databases, data, resources, location information, emoticons, virtual goods, stickers, contacts, status, updates, micro blogging, presence information, full or partial profile data or user contacts or connections, email conversations, clear conversations.

In another embodiment called user e.g. [Rahul Dev Burman] 505 and/or calling user e.g. [Yogesh Rathod] 605 is/are enable to apply, set, update & select setting for auto removal of chat messages or one or more types of shared messages or media or contents within particular period of time 577 and/or 677 from user's own device and are called user's device and from server's 110 database(s) 115.

In another embodiment called user e.g. [Rahul Dev Burman] 505 and calling user e.g. [Yogesh Rathod] 605 is/are enable to add chat conversation to story 575 or 675 and/or collaborative story 576 or 676 and save 580 or 680 current chat messages or conversations at user's local device or cloud storage or server or any other storage medium.

In another embodiment called user e.g. [Rahul Dev Burman] 505 and calling user e.g. [Yogesh Rathod] 605 is/are enable to provide rank or ratings or comments or reviews 588 or 688 to calling or called or chat participant users, report user 590 or 690 including report user as spammers, inappropriate, violate of terms & conditions & like, like 591 or 691 or dislike user 592 or 692, forward chat call or chat messages or conversations or one or more types of contents to one or more contacts.

In another embodiment real time chat call based chatting system's application or service can use push technology to provide real-time text, which transmits messages character by character, as they are composed.

In another embodiment chat user 505 or 605 are presented with duration 515 or 615 of chat conservation or chat session related conversation or sharing related to particular chat call.

In another embodiment chat user 505 or 605 are enabling to load earlier 518 chat messages or share contents.

In another embodiment called user e.g. [Rahul Dev Burman] 505 and/or calling user e.g. [Yogesh Rathod] 605 is/are enable to terminate or end or hang-up chat call 562 or 662. At the time of termination by called user e.g. [Rahul Dev Burman] 505 and/or calling user e.g. [Yogesh Rathod] 605 real time chat call based chatting system's application or service close or hide chat interface and chat session associate with particular chat call and based on privacy settings removes chat call associate messages, voice messages, logs, metadata, system data, shared media or contents from calling and/or called user's device(s) and/or server(s) and/or databases(s). In another embodiment before permanently removing of said chat call associate chat messages or chat conversations or shared media or contents, real time chat call based chatting system's application or service stores indexes of said chat call related messages, conversations, shared media or contents, logs, metadata & system data including called or calling user's identity, user names, mobile identity, location information, presence information, categories, shared link(s) associate contents, data, monitored, tracked & stored user's activities, actions, events, transactions, senses, location, check-in places, status, updates & behavior, voice to text data, chat call conversation related contextual or matched contents of/from one or more sources including search results from one or more sources, databases & like, date & time, duration of chat call or chat call related conversations, position of keyword(s) at black box index database(s) 115 of server(s) 110 (e.g. identify, mark, map, store & index keywords, dictionaries, key phrases, categories, taxonomies appeared in said chat call related shared contents, logs & messages) and make them available for or use for advertisers or advertisements or advertisement campaigns.

In another embodiment FIG. 7 illustrates exemplary presented graphical user interface (GUI) for enabling user to select, input, apply, set & update privacy settings and preferences related chat call including remove chat contents after end of chat call session 725, save chat call or chat call session related conversation 726, allow chat call associate shared content to add to story 727, allow chat call associate shared content add to collaborative story 728, enable real-time text i.e. use push technology to provide real-time text, which transmits messages character by character, as they are composed 731, allow anyone to chat call me 732, only allow people in my contact list to chat call me 733, allow to show status 735, Notification Settings 761 , About 765, manage, view, update & share user profile 766.

Chat Call Routing/ Forwarding 740 allows user to direct chat calls to single or multiple phone numbers, including user's home, office, mobile or any phone worldwide and allows for forwarding based on Caller ID or the time of day a call is received.

Blocked 741 i.e. Call Blocking allows user to block incoming chat calls from unwanted callers, unknown numbers or area codes. Easily block callers during a call or add them to user's blocking list in user's account.

Chat Call Transfer 742 is an In-Call Feature, allowing user to transfer incoming chat calls from user's phone to another phone number or extension at the press of a button. Call Transfer is activated using hard buttons or soft buttons on any phone.

Chat Call Waiting 743 i.e. switch between two concurrent incoming chat calls, when a second call arrives while users are on an ongoing call, user will hear a beep to indicate a call is waiting. By using the Flash Hook button, the send button or a quick on-hook, off-hook, the phone will switch between the two chat calls.

Chat Call Handling Rules 745 are the set of options created by user to route incoming chat calls to user's account to user's desired location. Using Call Handling Rules, user can route incoming chat calls to a single destination, or different destinations based on the day and time or the Caller ID of the chat call received. With Call Handling Rules, user can send chat calls to Voicemail—have user's messages sent to user as a .mp3 file, Custom greetings—create your own audio messages, Menus—make a set of options users can select, user's computer—send and receive on user desktop.

Chat Call Schedules 746 allow user to route incoming chat calls to different numbers, extensions, greetings, menus and more based on the day and time the call is received. A call received during business hours can be set to have user's normal greeting while a call received after business hours can be set to have user's After-Hours Greeting. User can plan ahead for holidays and days off. Each schedule allows user to define exceptions for holidays, vacations and other events. Exceptions allow user to bypass user's regular schedule and perform another action for a defined period of time. User can define as many schedules and exceptions as you need.

Do Not Disturb 748 when activated will cause the phone to automatically ignore any chat calls and send them to the next action in user's designated call handling rules

Respond with Text 750 enable user to respond with text to calling user when user is not available or busy.

Show my caller ID 751 enables the phone number of the calling party to be displayed on user's phone. Using Call Forwarding or Call Blocking, user can send specific callers to different locations (voicemail. greeting, disconnect, etc) based on their Caller ID.

Reminders 753 enabling user to remind chat call to one or more contacts.

Tell Friends/Invite 755 option enable user to invite non-registered users of real time chat call based chatting system's application or service in user's contacts for enabling them to install or subscribe or user or access real time chat call based chatting system's application or service and chat calling to each other.

Chat Call Notification 757 option enabling user to setup user's account to send a simple notification via email and/or SMS (text) message for incoming chat calls. Messages contain the Caller ID of the caller, the number or extension they dialed, date, time and duration of the call.

Chat Call Recording 760 i.e. monitors, reviews, indexes and saves chat calls and associate shared messages or contents to user's account.

Manage user account 767 including manage subscriptions, payments, change device or mobile or smart phone number, delete account and view network usage including number of messages send or receive, media or message byte shared, Backup 768 enabling user to take backup and/or email conversations 772 of all or selected chat calls related conversation, sharing, environment, activities, actions, events, transactions & logs and Restore 770 enabling user to restore chat call associate data and environment

Network Status 773 including presenting user with status of internet network is connected or not connected.

Chat Interface Settings 777 enabling user to set, select & apply Font, Size, Color, Wallpaper, Ring Tones, Notifications.

Multi Users Settings 778 enables administrators to create user accounts, assign rights, privileges, policies, privacy settings and preferences, assign allowed features and access of types of chat calls and like, manage extensions, interactive Options & Queues.

Chat Call Logs 780 enabling user to view & access recent, incoming, outgoing, cancelled, & missed chat call, associate duration, date & time.

Add Contact option 785 enables user to search, match & select users of networks or friends, import contacts, invite contacts, save a chat call number.

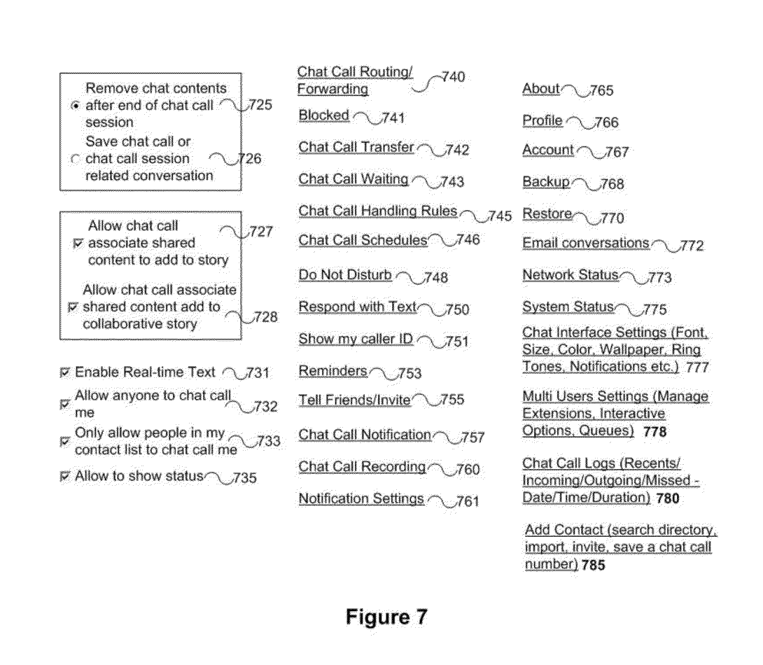

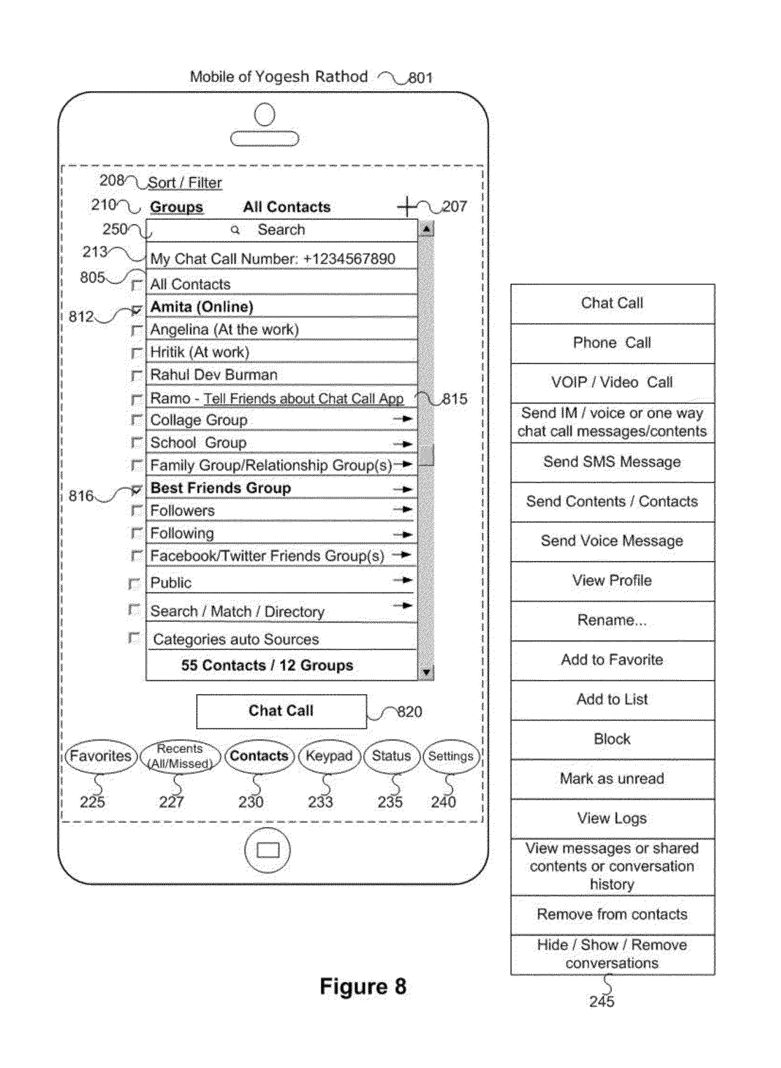

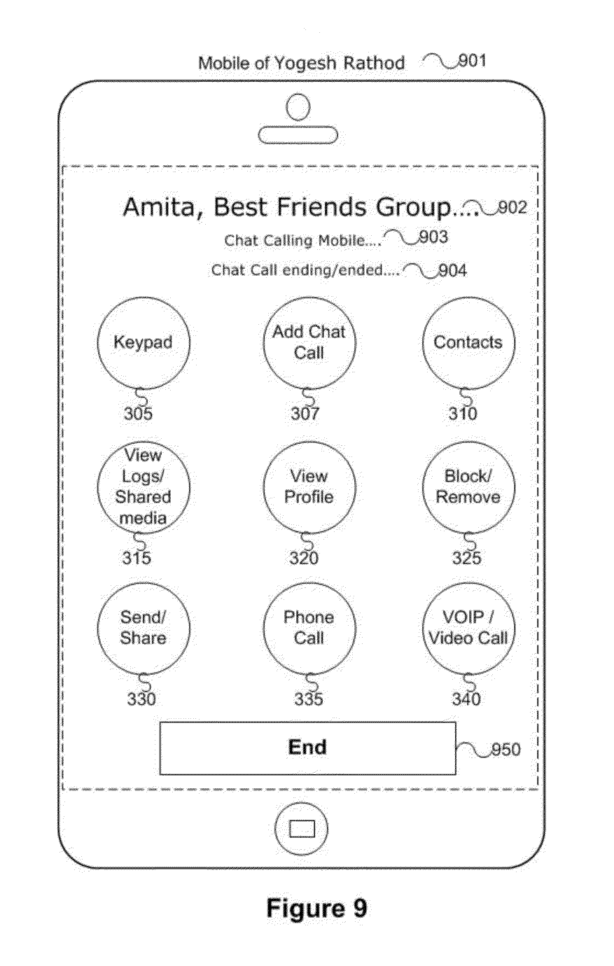

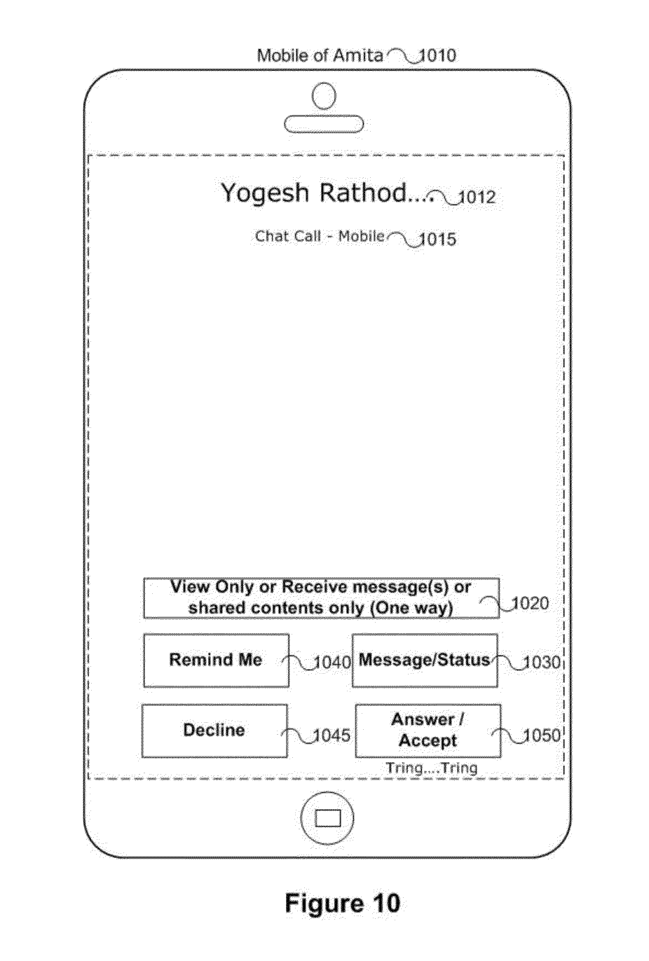

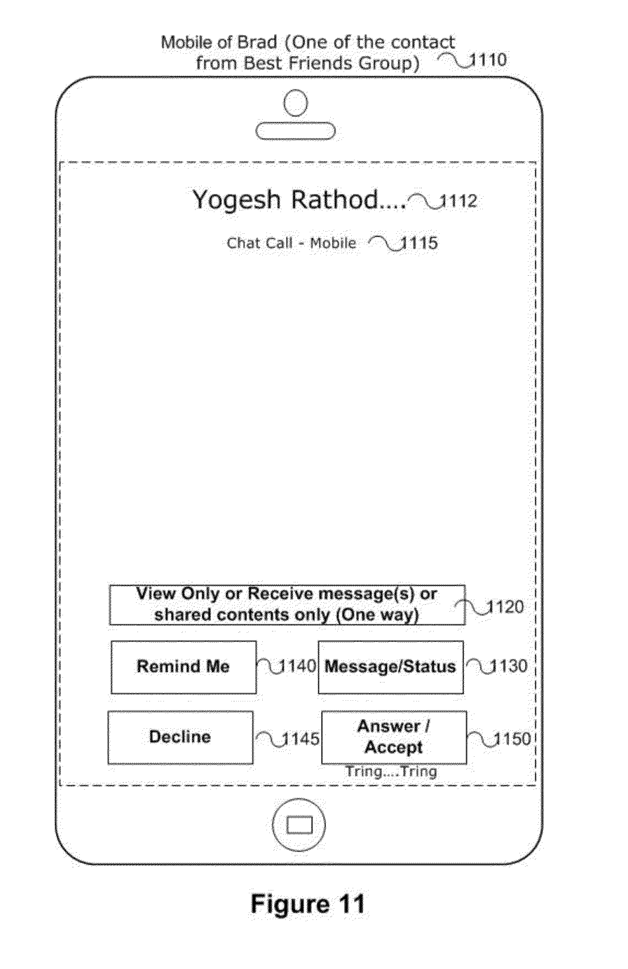

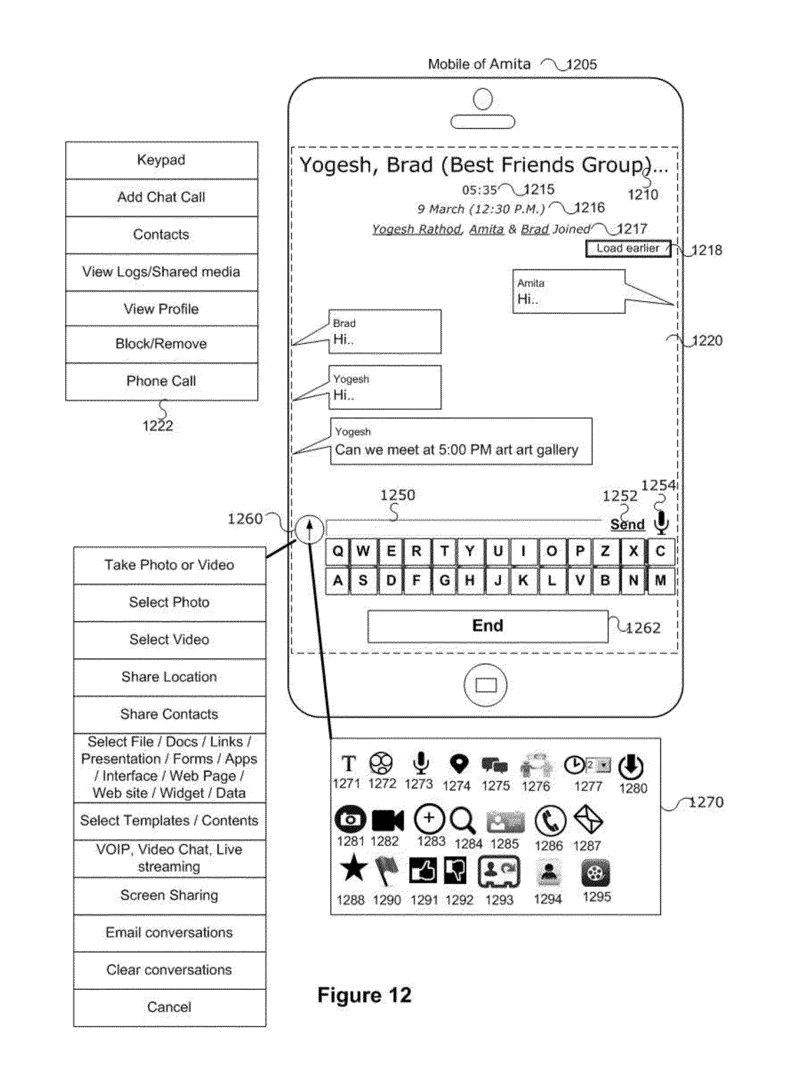

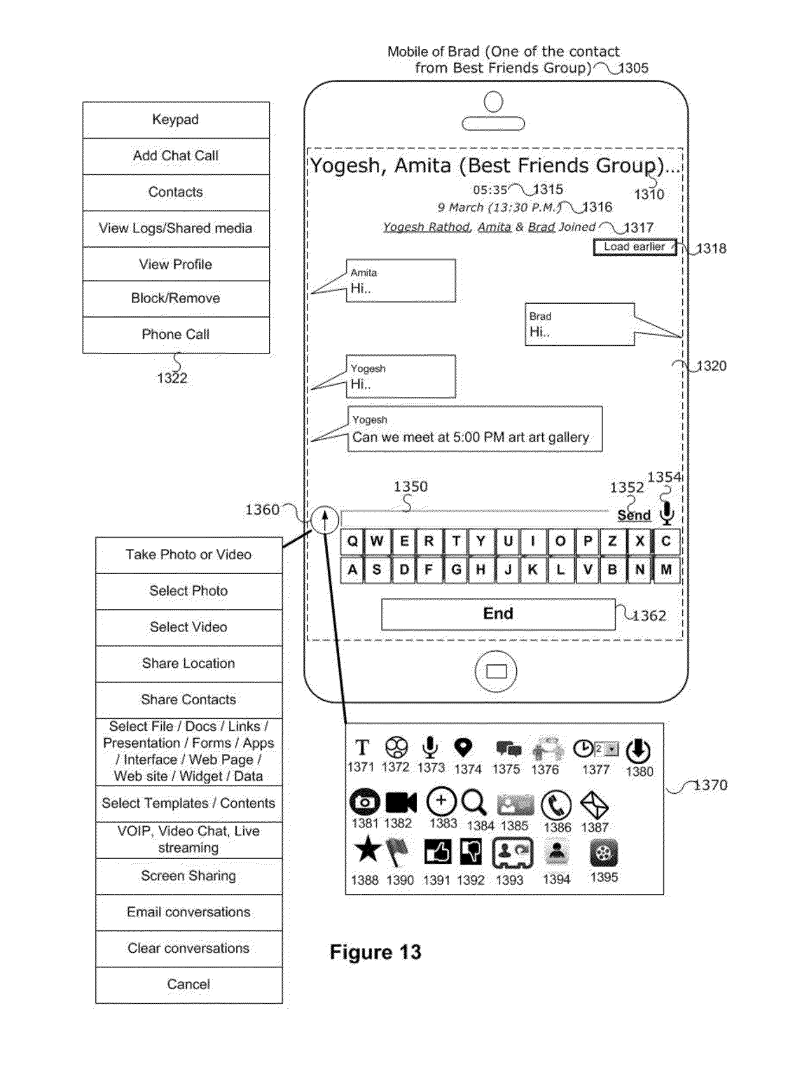

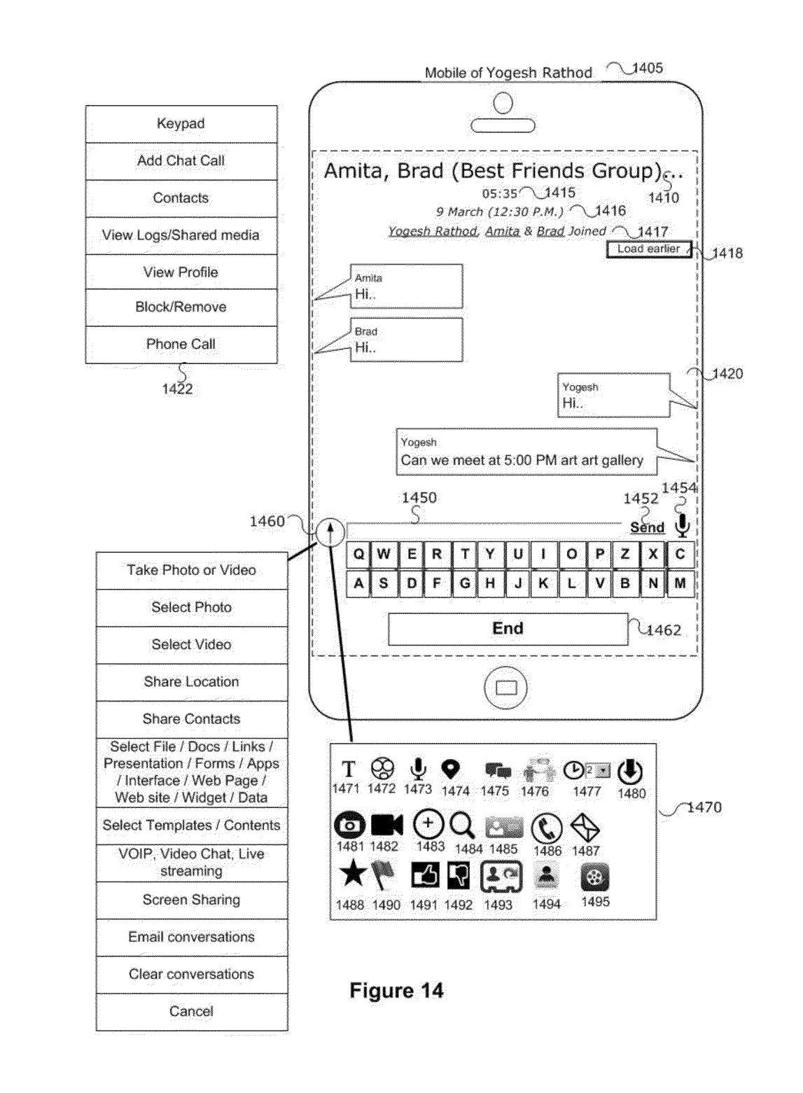

FIGS. 8 to 14 illustrates exemplary graphical user interface (GUI) relates to group chat call by calling user (e.g. user [Yogesh Rathod] 801) by using device 130 to selected called users (e.g. contact user [Amita] 812 and contact group [Best Friends Group] 816) at their device 135 or 145 from contacts 805 via clicking or tapping chat call button 820. FIG. 9 illustrates presented exemplary graphical user interface (GUI) to calling user 901 at the time of calling to selected contact users 902. Calling user wait for response or answer or acceptance of chat call from one or more called user(s) or user(s) from group(s) 903. Calling user can end or terminate chat call 950/904 before chat call accepted by called user(s) or after chat call accepted by called user or during establishment of chat call session between calling user(s) and called user(s). In the event of acceptance of chat call from one or more called users via clicking or tapping “Answer/Accept” button by called user [Amita] 1010 from installed application at user device 135 and one of the member of group [Best Friends Group] user [Brad] 1110 or from installed application at user device 145, real time chat call based chatting system's application or service present chat interface to calling user [Yogesh Rathod] 1450 and first and subsequent call accepted users [Amita] 1205 and [Brad] 1305. Calling and called users can communicate, collaborate, share or send or receive messages 1252, 1352 & 1452, voice messages 1254, 1354 & 1454 and one or more types of media via various options or menu 1260/1270, 1360/1370 & 1460/1470 as discuss in detail in FIGS. 5 & 6 (560/570 & 660/670). Each joined user's name and link or profile object 1217, 1317 & 1417 presented to each participated users, wherein viewing user can access or click or tap on said link and can view shared profile, status, availability or presence information, updates, associate user actions including email, call, save conversation, remove conversation after chat call setting, block, forward or route, assign, transfer, clear conversation, email conversation, remove from contact, end chat call with said user, provide ratings & comments, like or dislike, send instant message, share one or more types of media, view current conversation of said users, view media shared by said user, saved history or logs or activities of said link associate user of said users. Based on setting call terminated or ended in the event of calling user end or terminate chat call 1462 or chat call terminated up-to one of the last two participant ends chat call 1262 or 1362 or any other joined or participants of chat call or chat call terminated up-to the last participant end chat call. Length of duration or period of time of collaborative chat call session or chat call conversation is display to all chat call participants 1215, 1315 & 1415. Each chat call participants can view send or receive messages or shared contents at chat interface 1220, 1320 & 1420. Chat call participants can send or receive or share one or more types of media from/to one or more selected participants of chat call. Chat participant users 1205, 1305 & 1405 can use or access other options or features or user actions or functions 1222, 1322 & 1422 as discussed in FIG. 3.

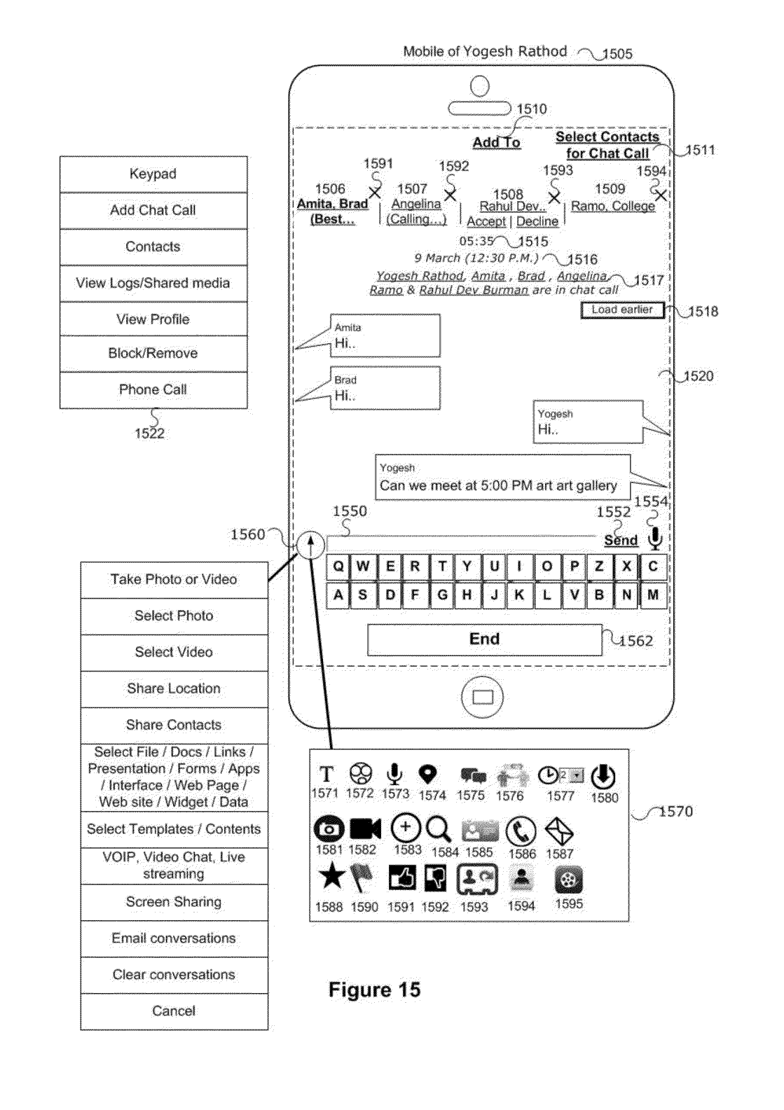

FIGS. 15 illustrates exemplary graphical user interface (GUI) for enabling user (e.g. user [Yogesh Rathod] 1505) to manage, view, access one or more chat calls including chat with existing connected called users via chat call associate chat interface 1520, initiate new chat call with one or more or group(s) of contacts 1511 ,chat call initiated by calling user to one or more or group(s) of called users 1507, chat call accepted by one or more called users 1506 & 1509, waiting for acceptance of chat calls 1507, accept or reject or ignore or remove or block chat calls of other calling users 1508, end or terminate existing chat calls 1562, 1591, 1592, 1593 & 1594, add or merge user to one or more chat calls 1510. User can switch or flip (1506, 1507, 1508 & 1509) chat call specific chat interface for chatting with particular chat call associate or chat call specific called or participated or active users. User can use various options, menus, features, functions and user actions 1522, 1560 & 1570 describe in details throughout the specification.

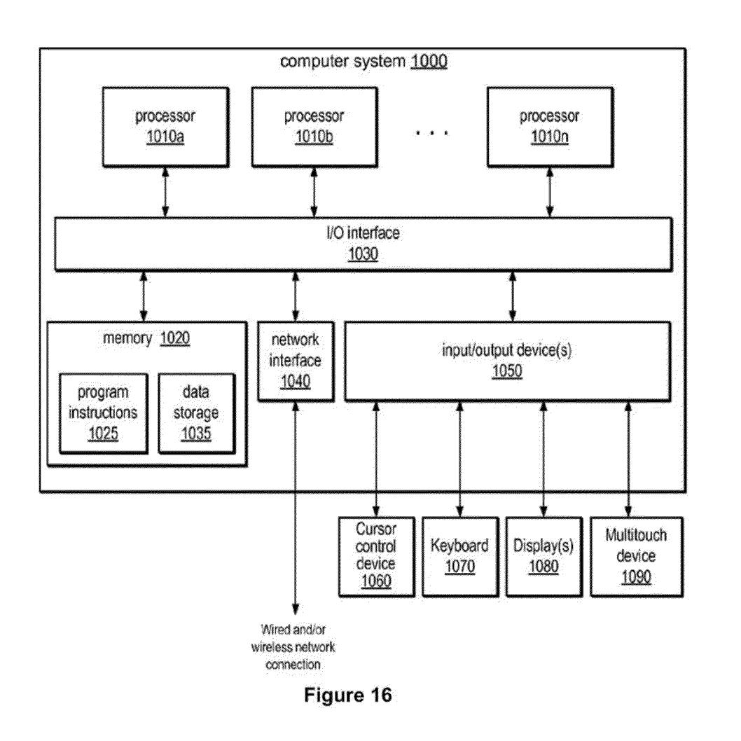

Various components of embodiments of methods as illustrated and described in the accompanying description may be executed on one or more computer systems, which may interact with various other devices. One such computer system is illustrated by FIG. 16. In different embodiments, computer system 1000 may be any of various types of devices, including, but not limited to, a personal computer system, desktop computer, laptop, notebook, or notebook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In the illustrated embodiment, computer system 1000 includes one or more processors 1010 coupled to a system memory 1020 via an input/output (I/O) interface 1030. Computer system 1000 further includes a network interface 1040 coupled to I/O interface 1030, and one or more input/output devices 1050, such as cursor control device 1060, keyboard 1070, multitouch device 1090, and display(s) 1080. In some embodiments, it is contemplated that embodiments may be implemented using a single instance of computer system 1000, while in other embodiments multiple such systems, or multiple nodes making up computer system 1000, may be configured to host different portions or instances of embodiments. For example, in one embodiment some elements may be implemented via one or more nodes of computer system 1000 that are distinct from those nodes implementing other elements.

In various embodiments, computer system 1000 may be a uniprocessor system including one processor 1010, or a multiprocessor system including several processors 1010 (e.g., two, four, eight, or another suitable number). Processors 1010 may be any suitable processor capable of executing instructions. For example, in various embodiments, processors 1010 may be general-purpose or embedded processors implementing any of a variety of instruction set architectures (ISAs), such as the x86, PowerPC, SPARC, or MIPS ISAs, or any other suitable ISA. In multiprocessor systems, each of processors 1010 may commonly, but not necessarily, implement the same ISA.

In some embodiments, at least one processor 1010 may be a graphics processing unit. A graphics processing unit or GPU may be considered a dedicated graphics-rendering device for a personal computer, workstation, game console or other computing or electronic device. Modern GPUs may be very efficient at manipulating and displaying computer graphics, and their highly parallel structure may make them more effective than typical CPUs for a range of complex graphical algorithms. For example, a graphics processor may implement a number of graphics primitive operations in a way that makes executing them much faster than drawing directly to the screen with a host central processing unit (CPU). In various embodiments, the methods as illustrated and described in the accompanying description may be implemented by program instructions configured for execution on one of, or parallel execution on two or more of, such GPUs. The GPU(s) may implement one or more application programmer interfaces (APIs) that permit programmers to invoke the functionality of the GPU(s). Suitable GPUs may be commercially available from vendors such as NVIDIA Corporation, ATI Technologies, and others.

System memory 1020 may be configured to store program instructions and/or data accessible by processor 1010. In various embodiments, system memory 1020 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing desired functions, such as those for methods as illustrated and described in the accompanying description, are shown stored within system memory 1020 as program instructions 1025 and data storage 1035, respectively. In other embodiments, program instructions and/or data may be received, sent or stored upon different types of computer-accessible media or on similar media separate from system memory 1020 or computer system 1000. Generally speaking, a computer-accessible medium may include storage media or memory media such as magnetic or optical media, e.g., disk or CD/DVD-ROM coupled to computer system 1000 via I/O interface 1030. Program instructions and data stored via a computer-accessible medium may be transmitted by transmission media or signals such as electrical, electromagnetic, or digital signals, which may be conveyed via a communication medium such as a network and/or a wireless link, such as may be implemented via network interface 1040.

In one embodiment, I/O interface 1030 may be configured to coordinate I/O traffic between processor 1010, system memory 1020, and any peripheral devices in the device, including network interface 1040 or other peripheral interfaces, such as input/output devices 1050. In some embodiments, I/O interface 1030 may perform any necessary protocol, timing or other data transformations to convert data signals from one component (e.g., system memory 1020) into a format suitable for use by another component (e.g., processor 1010). In some embodiments, I/O interface 1030 may include support for devices attached through various types of peripheral buses, such as a variant of the Peripheral Component Interconnect (PCI) bus standard or the Universal Serial Bus (USB) standard, for example. In some embodiments, the function of I/O interface 1030 may be split into two or more separate components, such as a north bridge and a south bridge, for example. In addition, in some embodiments some or all of the functionality of I/O interface 1030, such as an interface to system memory 1020, may be incorporated directly into processor 1010.

Network interface 1040 may be configured to allow data to be exchanged between computer system 1000 and other devices attached to a network, such as other computer systems, or between nodes of computer system 1000. In various embodiments, network interface 1040 may support communication via wired and/or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

Input/output devices 1050 may, in some embodiments, include one or more display terminals, keyboards, keypads, touchpads, scanning devices, voice or optical recognition devices, or any other devices suitable for entering or retrieving data by one or more computer system 1000. Multiple input/output devices 1050 may be present in computer system 1000 or may be distributed on various nodes of computer system 1000. In some embodiments, similar input/output devices may be separate from computer system 1000 and may interact with one or more nodes of computer system 1000 through a wired and/or wireless connection, such as over network interface 1040.

As shown in FIG. 16, memory 1020 may include program instructions 1025, configured to implement embodiments of methods as illustrated and described in the accompanying description, and data storage 1035, comprising various data accessible by program instructions 1025. In one embodiment, program instruction 1025 may include software elements of methods as illustrated and described in the accompanying description. Data storage 1035 may include data that may be used in embodiments. In other embodiments, other or different software elements and/or data may be included.

Those skilled in the art will appreciate that computer system 1000 is merely illustrative and is not intended to limit the scope of methods as illustrated and described in the accompanying description. In particular, the computer system and devices may include any combination of hardware or software that can perform the indicated functions, including computers, network devices, internet appliances, PDAs, wireless phones, pagers, etc. Computer system 1000 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Accordingly, the present invention may be practiced with other computer system configurations.

Various embodiments may further include receiving, sending or storing instructions and/or data implemented in accordance with the foregoing description upon a computer-accessible medium. Generally speaking, a computer-accessible medium may include storage media or memory media such as magnetic or optical media, e.g., disk or DVD/CD-ROM, volatile or non-volatile media such as RAM (e.g. SDRAM, DDR, RDRAM, SRAM, etc.), ROM, etc., as well as transmission media or signals such as electrical, electromagnetic, or digital signals, conveyed via a communication medium such as network and/or a wireless link.

The various methods as illustrated in the Figures and described herein represent examples of embodiments of methods. The methods may be implemented in software, hardware, or a combination thereof. The order of method may be changed, and various elements may be added, reordered, combined, omitted, modified, etc. Various modifications and changes may be made as would be obvious to a person skilled in the art having the benefit of this disclosure. It is intended that the invention embrace all such modifications and changes and, accordingly, the above description to be regarded in an illustrative rather than a restrictive sense.

In an embodiment a program is written as a series of human understandable computer instructions that can be read by a compiler and linker, and translated into machine code so that a computer can understand and run it. A program is a list of instructions written in a programming language that is used to control the behavior of a machine, often a computer (in this case it is known as a computer program).A programming language's surface form is known as its syntax. Most programming languages are purely textual; they use sequences of text including words, numbers, and punctuation, much like written natural languages. On the other hand, there are some programming languages which are more graphical in nature, using visual relationships between symbols to specify a program. In computer science, the syntax of a computer language is the set of rules that defines the combinations of symbols that are considered to be a correctly structured document or fragment in that language. This applies both to programming languages, where the document represents source code, and markup languages, where the document represents data. The syntax of a language defines its surface form. Text-based computer languages are based on sequences of characters, while visual programming languages are based on the spatial layout and connections between symbols (which may be textual or graphical or flowchart(s)). Documents that are syntactically invalid are said to have a syntax error. Syntax—the form—is contrasted with semantics—the meaning. In processing computer languages, semantic processing generally comes after syntactic processing, but in some cases semantic processing is necessary for complete syntactic analysis, and these are done together or concurrently. In a compiler, the syntactic analysis comprises the frontend, while semantic analysis comprises the backend (and middle end, if this phase is distinguished). There are millions of possible combinations, sequences, ordering, permutations & formations of inputs, interpretations, and outputs or outcomes of set of instructions of standardized or specialized or generalized or structured or functional or object oriented programming language(s).

The present invention has been described in particular detail with respect to a limited number of embodiments. Those of skill in the art will appreciate that the invention may additionally be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Furthermore, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component. Additionally, although the foregoing embodiments have been described in the context of a social network website, it will apparent to one of ordinary skill in the art that the invention may be used with any social network service, even if it is not provided through a website. Any system that provides social networking functionality can be used in accordance with the present invention even if it relies, for example, on e-mail, instant messaging or any other form of peer-to-peer communications, or any other technique for communicating between users. Systems used to provide social networking functionality include a distributed computing system, client-side code modules or plug-ins, client-server architecture, a peer-to peer communication system or other systems. The invention is thus not limited to any particular type of communication system, network, protocol, format or application.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

What is claimed is:

1. A method of communicating in a network performing real-time communications between a plurality of users, each user having a user computer associated therewith, each user computer being communicably coupled to at least one communications network and in a central unit, providing a communication facility that enables user to user calling functionality in a network environment, the method comprising: storing, at the central unit, unique identity of each registered user of network; enabling first user to select or tap on user(s) or contact(s) from list of users or contacts for calling or send invitation of call to said selected identified user(s) or contact(s); display or present outgoing call interface to said first user, wherein said interface enables or facilitates first user to end or terminate said call before acceptance of call by second user; receiving by the central unit, indication of said calling or invitation to second user from a first user in the plurality of users; sending by the central unit, indication of calling or invitation of first user to second user; present incoming call interface to second user and allow second user to accept, reject, remind later & respond with text said call or invitation of first user within particular period of time or duration or as per rules; in the event of acceptance of call or invitation by second user, display or present one or more type of interface(s) including chat or instant messenger or e-mail interface or application(s) or media to second user for communication or messaging or chatting with said first user or view media, wherein said interface enables or facilitates second user to end said call with first user or end communication session related to said call or close said interface; receiving by the central unit, indication of acceptance or rejection or missing or responding with text or holding of call or invitation from second user; sending by the central unit, indication of acceptance or rejection or missing or responding with text or holding of said call or invitation to first user; in the event of acceptance of call or invitation by second user or receiving of indication of acceptance of call or invitation from second user, display or present one or more type of interface(s) including chat or instant messenger or e-mail interface or application(s) or media to first user for communication or messaging or chatting with said second user or view media wherein said interface enables or facilitates first user to end said call with second user or end communication session related to said call or close said interface; receiving by the central unit, indication of ending of said call or ending of said call related communication session from first user or second user; sending by the central unit, indication of ending of said call or ending of said call related communication session from first user to second user or from second user to first user; and based on said indication ending of said call or ending of said communication session or close one or more type(s) of interface(s) including chat, instant messenger interface from first user device and second user device which prevents first user and second user to communicate including chatting or instant messaging with each other.

2. The method of claim 1 wherein select user(s) or contact(s) from list of users or contacts comprises unique identity, unique phone numbers of phone book of device, unique user name, unique identity of social network including Facebook, Twitter and Google identity, email address, group(s), category or set of contacts and list of user(s) or contact(s) who installed one or more type of client application including online, offline & smart client, which connected or connectable with said central unit, at one or more type of devices including mobile, personal computer & tablet for calling and communicating with users of network.

3. The method of claim 1 wherein enable user to capture or record and/or select pre-stored or select said captured or recorded one or more type(s) of one or more media item(s) including audio, video and photo; enable to selecting or tapping on user(s) or contact(s) from list of users or contacts for calling or send invitation of call to said selected identified user(s) or contact(s), wherein in the event of acceptance of call or invitation by second user or receiving of indication of acceptance of call or invitation from second user, display or present said one or more type(s) of one or more media item(s) to second user.

4. The method of claim 1 wherein allow second user to accept, reject, remind later & respond with text said call or invitation of first user within particular period of time or duration or as per rules, wherein in the absence of non-acceptance or non-rejection or non-responding with text or non-reminding later selection of option of said call or invitation, treat call as missed call and inform about said miss call to first user and second user.

5. The method of claim 1 wherein present one or more type of interface(s) including chat or Instant Messenger or Email interface or SMS/MMS Interface(s) or application(s) or one or more type of client application including online, offline & smart client or data or media contents from one or sources including from local storage, local device, servers, networks, storage mediums, databases, web sites, applications, services & devices comprises enable to pre-configure or pre-set or auto identified or pre-select one or more type of application(s) to show to calling and/or called user(s) while call acceptance by called user(s).

6. The method of claim 1 wherein enable to and inform about pause or restart of said established communication or call between first and second user to first and second user, wherein in the event of pause preventing first user and second user to communicate with each other and in the event of restart enabling first and second user to communicate with each other.

7. A system of communicating in a network performing real-time communications between a plurality of users, each user having a user computer associated therewith, each user computer being communicably coupled to at least one communications network and in a central unit, providing a communication facility that enables user to user calling functionality in a network environment, the system comprising: storage medium is configure at the central unit for storing unique identity of each registered user of network; interface is configure to enable first user to select or tap on user(s) or contact(s) from list of users or contacts for calling or send invitation of call to said selected identified user(s) or contact(s); interface is configure to allow first user to end or terminate said call before acceptance of call by second user; a module is configure at central unit to receive indication of said calling or invitation to second user from a first user in the plurality of users; a module is configure at central unit to send indication of calling or invitation of first user to second user; interface is configure to allow second user to accept, reject, remind later & respond with text said call or invitation of first user within particular period of time or duration or as per rules; in the event of acceptance of call or invitation by second user, display or present one or more type of interface(s) including chat or instant messenger or e-mail interface or application(s) or media to second user for communication or messaging or chatting with said first user or view media, wherein said interface enables or facilitates second user to end said call with first user or end communication session related to said call or close said interface; a module is configure at central unit to receive indication of acceptance or rejection or missing or responding with text or holding of call or invitation from second user; a module is configure at central unit to send indication of acceptance or rejection or missing or responding with text or holding of said call or invitation to first user; in the event of acceptance of call or invitation by second user or receiving of indication of acceptance of call or invitation from second user, display or present one or more type of interface(s) including chat or Instant Messenger or Email interface or application(s) or media to first user for communication or messaging or chatting with said second user or view media wherein said interface enables or facilitates first user to end said call with second user or end communication session related to said call or close said interface; a module is configure at central unit to receive indication of ending of said call or ending of said call related communication session from first user or second user; a module is configure at central unit to send indication of ending of said call or ending of said call related communication session of first user to second user or send indication of ending of said call or ending of said call related communication session of second user to first user; and a module is configure to, based on said indication of ending of call, end said call or end said communication session or close one or more type of presented interface(s) including chat or instant messenger interface or application of/from first user device and second user device which prevents first user and second user to communicate including or chat or instant messaging with each other.

8. The system of claim 7 wherein select user(s) or contact(s) from list of users or contacts comprises unique identity, unique phone numbers of phone book of device, unique user name, unique identity of social network including Facebook, Twitter and Google identity, email address, group(s), category or set of contacts and list of user(s) or contact(s) who installed one or more type of client application including online, offline & smart client, which connected or connectable with said central unit, at one or more type of devices including mobile, personal computer & tablet for calling and communicating with users of network.

9. The system of claim 7 wherein user is enable to capture or record and/or select pre-stored or select said captured or recorded one or more type(s) of one or more media item(s) including audio, video and photo; enable to selecting or tapping on user(s) or contact(s) from list of users or contacts for calling or send invitation of call to said selected identified user(s) or contact(s), wherein in the event of acceptance of call or invitation by second user or receiving of indication of acceptance of call or invitation from second user, display or present said one or more type(s) of one or more media item(s) to second user.

10. The system of claim 7 wherein second user is enable to accept, reject, remind later & respond with text said call or invitation of first user within particular period of time or duration, wherein in the absence of non-acceptance or non-rejection or non-responding with text or non-reminding later selection of option of said call or invitation, treat call as missed call and inform about said miss call to first user and second user.

11. The system of claim 7 wherein present one or more type of interface(s) including chat or instant messenger or e-mail interface or application(s) or one or more type of client application including online, offline & smart client or data or media contents from one or sources including from local storage, local device, servers, networks, storage mediums, databases, web sites, applications, services & devices comprises enable to pre-configure or pre-set or auto identified or pre-select one or more type of application(s) to show to calling and/or called user(s) while call acceptance by called user(s).

12. The system of claim 7 wherein user is enable to and inform about pause or restart of said established communication or call between first and second user to first and second user, wherein in the event of pause preventing first user and second user to communicate with each other and in the event of restart enabling first and second user to communicate with each other.

13. A method of performing real-time communications between a plurality of users, each user having a user computer associated therewith, each user computer being communicably coupled to at least one communications network and in a central unit, providing a communication facility that enables user to user calling functionality and in the event of call acceptance accessing of one or more types of interfaces, the method comprising: storing, at the central unit, unique identity of each registered user of network; enabling first user to select user(s) or contact(s) from list of users or contacts for calling or send invitation of call to said selected identified user(s) or contact(s); initiating or establishing one or more type of communication session including chat or instant messenger session between first and second users and present one or more type of interface(s) or application(s) or media to first user and second user in the event of acceptance of call or invitation of first user by second user within particular or pre-set period of time or duration or as per rules; and ending of one or more type of communication session including ending of chat or instant messenger session between first and second users and closing or hiding or terminating one or more type of interface(s) or application(s) from first user device and second user device in the event of ending of call or providing indication of ending of call or ending of communication session by first user or second user, which prevents first user and second user to use or access said one or more type of said presented interface(s) or application(s) and prevents communicates with each other.

14. The method of claim 13 wherein, display one or more type of interface(s) including chat or instant messenger or e-mail interface or application(s) or data or media contents to first and second user in the event of call or invitation of first user accept by second user

15. The method of claim 13 wherein, hide or close interface(s) of both first and second users in the event of ending of call or providing indication of ending of communication session by first user or second user.

16. The method of claim 13 wherein select user(s) or contact(s) from list of users or contacts comprises unique identity, unique phone numbers of phone book of device, unique user name, unique identity of social network including Facebook, Twitter and Google identity, email address, group(s), category or set of contacts and list of user(s) or contact(s) who installed one or more type of client application including online, offline & smart client, which connected or connectable with said central unit, at one or more type of devices including mobile, personal computer & tablet for calling and communicating with users of network.

17. The method of claim 13 wherein enable user to capture or record and/or select pre-stored or select said captured or recorded one or more type(s) of one or more media item(s) including audio, video and photo; enable to selecting or tapping on user(s) or contact(s) from list of users or contacts for calling or send invitation of call to said selected identified user(s) or contact(s), wherein in the event of acceptance of call or invitation by second user or receiving of indication of acceptance of call or invitation from second user, display or present said one or more type(s) of one or more media item(s) to second user.

18. The method of claim 13 wherein allow second user to accept, reject, remind later & respond with text said call or invitation of first user within particular period of time or duration or as per rules, wherein in the absence of non-acceptance or non-rejection or non-responding with text non-reminding later selection of option of said call or invitation, treat call as missed call and inform about said miss call to first user and second user.

19. The method of claim 13 wherein present one or more type of interface(s) including chat or Instant Messenger or Email interface or SMS/MMS Interface(s) or application(s) or one or more type of client application including online, offline & smart client or data or media contents from one or sources including from local storage, local device, servers, networks, storage mediums, databases, web sites, applications, services & devices comprises enable to pre-configure or pre-set or auto identified or pre-select one or more type of application(s) to show to calling and/or called user(s) while call acceptance by called user(s).

20. The method of claim 13, wherein enabling auto chat calling to one or more contacts and/or users of network(s), wherein in said auto chat calling may base on one or more types of user's activities, actions, interactions, events, transactions, senses, locations, check-in place(s), schedule, behavior, logs, status, updates, presence information, auto identification of requirements, tasks, workflow, past chat calls, past chat call associate data, user profile, user data & metadata, shared contents and user contacts or connections.
